(19) United States
(12) Patent Application Publication
(10) Pub. No.: US 2025/0325159 A1
(43) Pub. Date: Oct. 23, 2025

(54) SYSTEMS AND METHODS FOR ROBOTIC ALLEY AREA CLEANING

(71) Applicant: The Procter & Gamble Company, Cincinnati, OH (US)

(72) Inventors: Joost DEBONTH, Schaarbeek (BE); Matthew Stephen BAUER, Loveland, OH (US); Eric Gunnar HURD, Cincinnati, OH (US); Su Yon CHANG, Mason, OH (US)

(21) Appl. No.: 19/182,791

(22) Filed: Apr. 18, 2025

Related U.S. Application Data
(60) Provisional application No. 63/636,299, filed on Apr. 19, 2024.

(51) Int. Cl. A47L 11/40; G05D 1/648; G05D 105/10

(52) U.S. Cl. CPC A47L 11/4011; A47L 11/4066; G05D 1/6484; A47L 2201/04; G05D 2105/10

(57) ABSTRACT

A robot is described herein for robotic cleaning and navigation strategies. The robot may be sized or dimensioned for maneuvering for cleaning, disinfecting, or otherwise improving a physical environment (e.g., living spaces, office spaces, or the like), especially those having narrow or varied spaces created by obstacles within the physical environment. The cleaning robot as described herein provide solutions for overcoming problems that arise from cleaning target areas or environments that have typically been hard for conventional robots to clean, fit, and/or maneuver within, such as a hallway or alley cleaning area or space.

### FIELD

The present disclosure generally relates to robots, such as cleaning robot automation, and more particularly to, the field of robotics applied to cleaning, disinfecting, or otherwise improving a physical environment (e.g., living spaces, office spaces, or the like), especially those having narrow or varied spaces created by obstacles within the physical environment such as a hallway or alley cleaning area or space.

### BACKGROUND

Existing cleaning robots lack the ability to maneuver or navigate into complex, e.g., narrow and/or variable, spaces within a given physical environment. Typically, such cleaning robots are designed to have a wide or otherwise large cleaning footprint designed to clean a wide-open area as the robot moves within a given space. Such large design, however, is prohibitive to effective cleaning in complex spaces, leaving such spaces uncleaned or otherwise unaffected by the cleaning robot.

Further, given their large size, conventional cleaning robots lack fine motor control necessary to navigate or move within complex spaces. While these conventional robots can perform algorithms to clean a large space they fail to account for tight spaces and corners that are typically the most difficult to clean. This issue is especially problematic because physical environments can differ widely by having different shapes, sizes, and dimensions which prohibits large size robots from effective maneuvering, navigating, or otherwise operating to provide a thorough clean.

For the foregoing reasons, there is a need for a robot configured for cleaning, disinfecting, or otherwise improving a physical environment (e.g., living spaces, office spaces, or the like), especially those having narrow or varied spaces created by obstacles within the physical environment, or as otherwise created by the physical environment itself such as a hallway or alley cleaning area or space, as further described herein.

### SUMMARY

Generally, a cleaning robot is described herein. The cleaning robot may comprise high fidelity sensor(s) (e.g., joystick or other data rich sensors) for accurate control, maneuverability, or otherwise advanced robotic navigation strategies. Further, in various aspects, the cleaning robot may be sized or dimensioned for maneuvering, cleaning, disinfecting, or otherwise improving a physical environment (e.g., living spaces, office spaces, or the like), especially in areas having narrow or varied spaces created by obstacles or edges (e.g., walls) within the physical environment. The cleaning robots as described herein provide solutions for overcoming problems that arise from cleaning target areas or environments that have typically been hard for conventional robots to clean, fit, and/or maneuver within such as a hallway or alley cleaning area or space.

More specifically, in some aspects, the techniques described herein relate to a robot configured for cleaning, the robot including: a body including a chassis and an outer perimeter, and the body further including a front portion, an opposing back portion, and a body length disposed between the front portion and the opposing back portion, wherein the body further includes a cleaning element positioned relative to the front portion, wherein the front portion includes a first side, an opposing second side, and a front portion width disposed between the first side and the second side (e.g., a left-to-right dimension); a motor configured to move the robot within an environment; at least one sensor; a processor communicatively coupled to the at least one sensor; a computer memory communicatively coupled to the processor; and computing instructions stored on the computer memory and configured, when executed by the processor, to cause the processor to: actuate the motor to drive the robot in a first direction, wherein the robot moves in a confined area (e.g., an alley) within the environment, the confined area having a first boundary and a second boundary, and a confined area width extending between the first boundary and the second boundary, wherein the confined area width is sized greater than the front portion width of the robot; actuate the motor to rotate the robot relative to the first direction; detect, by the at least one sensor, the first boundary or the second boundary which prevents the robot from rotating less than or equal to 90 degrees relative to the first direction; actuate the motor to maneuver a first side against the first boundary or the second side against the second boundary; and actuate the motor to maneuver in second direction, the second direction being an opposite (e.g., a reverse) direction relative to the first direction.

In some aspects, the techniques described herein relate to a robot, wherein the computing instruction stored on the computer memory and configured, when executed by the processor, to cause the processor to further: actuate the motor to remaneuver the robot in the first direction, wherein the robot drives along the first boundary or second boundary until the at least one sensor detects a third boundary which is disposed at an angle with respect to the first boundary or the second boundary.

In some aspects, the techniques described herein relate to a robot, wherein the third boundary is generally perpendicular to the first and/or second boundary.

In some aspects, the techniques described herein relate to a robot, wherein the computing instruction stored on the computer memory and configured, when executed by the processor, to cause the processor to further: actuate the motor to remaneuver the robot in the first direction, wherein the robot drives along the first boundary or second boundary to cover (e.g., to clean) with the cleaning element (e.g., a cleaning pad) at least one portion of the confined area not previously covered (e.g., cleaned) by the cleaning element when the robot was prevented from rotating by less than or equal to 90 degrees.

In some aspects, the techniques described herein relate to a robot, wherein the robot drives along the first boundary in the first direction, and wherein the robot drives along the second boundary in the second direction.

In some aspects, the techniques described herein relate to a robot, wherein when the robot drives in the second direction, a longitudinal axis of the robot is disposed at an angle with respect to a longitudinal axis of the confined area.

In some aspects, the techniques described herein relate to a robot, wherein when the robot drives in the second direction, the robot drives a first distance and then rotates with respect to the second direction.

In some aspects, the techniques described herein relate to a robot, wherein if the robot detects, via the at least one sensor, the first boundary or the second boundary, which prevents the robot from rotating less than or equal to 90 degrees relative to the second direction, the robot continues to drive in the second direction by a second distance.

In some aspects, the techniques described herein relate to a robot, wherein if the robot detects, via the at least one sensor, the first boundary or the second boundary, which prevents the robot from rotating less than or equal to 90 degrees relative to the second direction, the robot continues to drive in the second direction by a third distance.

In some aspects, the techniques described herein relate to a robot, wherein the first boundary or the second boundary prevents the robot from rotating less than or equal to 60 degrees relative to the first direction.

In some aspects, the techniques described herein relate to a robot, wherein the first boundary or the second boundary prevents the robot from rotating less than or equal to 45 degrees relative to the first direction.

In some aspects, the techniques described herein relate to a robot, wherein alley defines multiple areas (e.g., 1st, 2nd, 3rd, 4th, and 5th) defined by the first boundary (e.g., a first wall) and the second boundary (e.g., a second wall).

In some aspects, the techniques described herein relate to a robot, wherein the sensor is a displacement sensor. Some suitable non-limiting examples of displacement sensors include a hall effect sensor, etc., motor current sensor, inertial measurement unit “IMU” sensor, a joystick sensor, a potentiometer, pressure switch, time of flight, capacitive, the like or combinations thereof.

In some aspects, the techniques described herein relate to a robot, wherein the computing instructions are further configured, when executed by the processor, to cause the processor to: detect by the at least one sensor, a third boundary (e.g., a third wall) as the robot travels in the second direction (e.g., backing up towards a first wall); actuate the motor maneuver the robot in a third direction, the third direction being at an angle (e.g., 90 degrees) to the second direction, and wherein travel in the third direction moves the robot away from the confined area (e.g., the alley defined by third, fourth, and fifth walls) into a second confined area having a third boundary (e.g., the first wall) and a fourth boundary (e.g., a second wall).

The present disclosure relates to improvements to other technologies or technical fields at least because the present disclosure describes or introduces improvements to computing devices in the field of robotics, whereby a cleaning robot, as described herein, may comprise high fidelity sensor control (e.g., via joystick or other data rich sensors) for robotic navigation strategies. For example, the high-fidelity sensor control configures the robot for moving or otherwise navigating the robot within a physical environment such as a hallway or alley cleaning area or space, as further described herein.

The present disclosure includes applying the certain of the aspect elements with, or by use of, a particular machine, e.g., a robot configured for cleaning, disinfecting, or otherwise improving a physical environment (e.g., living spaces, office spaces, or the like).

In addition, the present disclosure includes specific features other than what is well-understood, routine, conventional activity in the field, and that add unconventional steps that confine the claim to a particular useful application, e.g., cleaning robots configured to clean, disinfect, and/or otherwise improve a physical environment (e.g., living spaces, office spaces, or the like), especially those having narrow or varied spaces created by obstacles within the physical environment such as a hallway or alley cleaning area or space.

Advantages will become more apparent to those of ordinary skill in the art from the following description of the preferred aspects which have been shown and described by way of illustration. As will be realized, the present aspects may be capable of other and different aspects, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the system and methods disclosed therein. It should be understood that each Figure depicts a particular aspect of the disclosed system and methods, and that each of the Figures is intended to accord with a possible aspect thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present aspects are not limited to the precise arrangements, orientations, and/or instrumentalities shown, wherein:

FIG. 1 illustrates a perspective view of an example robot for cleaning or otherwise interacting with a space or environment in accordance with various aspects disclosed herein.

FIG. 2A illustrates an exploded view of a portion of the example robot of FIG. 1 in accordance with various aspects disclosed herein.

FIG. 2B illustrates a further exploded view of the example robot of FIG. 1 in accordance with various aspects disclosed herein.

FIG. 2C illustrates a top-down cross-sectional view of the example robot of FIG. 1 in accordance with various aspects disclosed herein.

FIG. 3 illustrates a top view of the example robot of FIG. 1 in accordance with various aspects disclosed herein.

FIG. 4 illustrates a bottom view of the example robot of FIG. 1 in accordance with various aspects disclosed herein.

FIG. 5 illustrates a side view of the example robot of FIG. 1 in accordance with various aspects disclosed herein.

FIG. 6 illustrates a rear view of the example robot of FIG. 1 in accordance with various aspects disclosed herein.

FIG. 7 illustrates a front view of the example robot of FIG. 1 in accordance with various aspects disclosed herein.

FIG. 8 illustrates an example environment in which the robot of FIG. 1 can navigate or otherwise move within in accordance with various aspects disclosed herein.

FIG. 9A illustrates an example multi-directional sensor in accordance with various aspects disclosed herein.

FIG. 9B illustrates the example multi-directional sensor of FIG. 9A with an example plurality or set of plurality of radial zones in accordance with various aspects disclosed herein.

FIG. 10A illustrates an example magnetic-based multi-directional sensor configuration in accordance with various aspects disclosed herein.

FIG. 10B illustrates an example Hall-effect-based multi-directional sensor configuration in accordance with various aspects disclosed herein.

FIG. 10C illustrates an example Time-of-Flight (ToF) s-based multi-directional sensor configuration in accordance with various aspects disclosed herein.

FIG. 11 illustrates a coverage diagram showing example navigation or movement of a robot within an environment in accordance with various aspects disclosed herein.

FIG. 12 illustrates a flowchart for a navigation algorithm for a robot maneuvering within a confined area (e.g., such as a hallway or alley cleaning area or space) in accordance with various aspects disclosed herein.

FIG. 13A illustrates example navigation or movement of a robot within a confined area in accordance with various aspects disclosed herein.

FIG. 13B illustrates further example navigation or movement of a robot within the confined area of FIG. 13A in accordance with various aspects disclosed herein.

FIG. 13C illustrates further example navigation or movement of a robot within the confined area of FIGS. 13A-13B in accordance with various aspects disclosed herein.

FIG. 13D illustrates further example navigation or movement of a robot within the confined area of FIGS. 13A-13C in accordance with various aspects disclosed herein.

FIG. 13E illustrates further example navigation or movement of a robot within the confined area of FIGS. 13A-13D in accordance with various aspects disclosed herein.

FIG. 13F illustrates further example navigation or movement of a robot within the confined area of FIGS. 13A-13E in accordance with various aspects disclosed herein.

FIG. 13G illustrates further example navigation or movement of a robot within the confined area of FIGS. 13A-13F in accordance with various aspects disclosed herein.

FIG. 13H illustrates further example navigation or movement of a robot within the confined area of FIGS. 13A-13G in accordance with various aspects disclosed herein.

FIG. 14 illustrates example navigation or movement of a robot within a further example environment in accordance with various aspects disclosed herein.

FIG. 15 illustrates a flowchart for a stuck state algorithm for a robot maneuvering within in an environment in accordance with various aspects disclosed herein.

FIG. 16 illustrates a flowchart for an edge state to stuck state transition algorithm for a robot maneuvering within in an environment in accordance with various aspects disclosed herein.

FIG. 17 illustrates example debris and sizes thereof in accordance with various aspects disclosed herein.

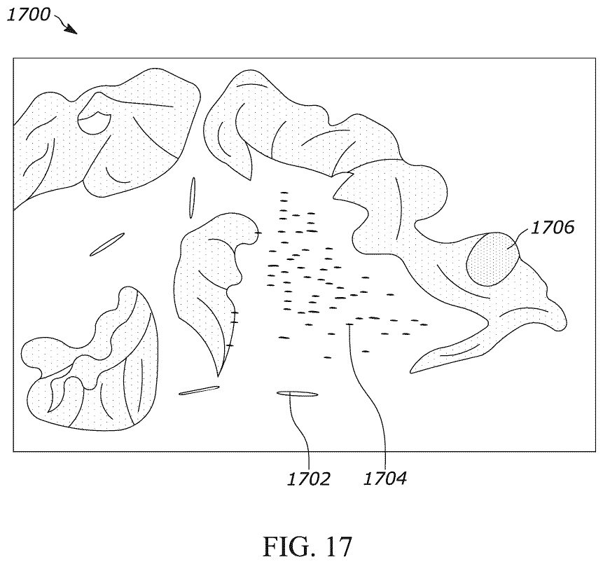

The Figures depict preferred aspects for purposes of illustration only. Alternative aspects of the systems and methods illustrated herein may be employed without departing from the principles of the invention described herein.

### DETAILED DESCRIPTION OF THE INVENTION

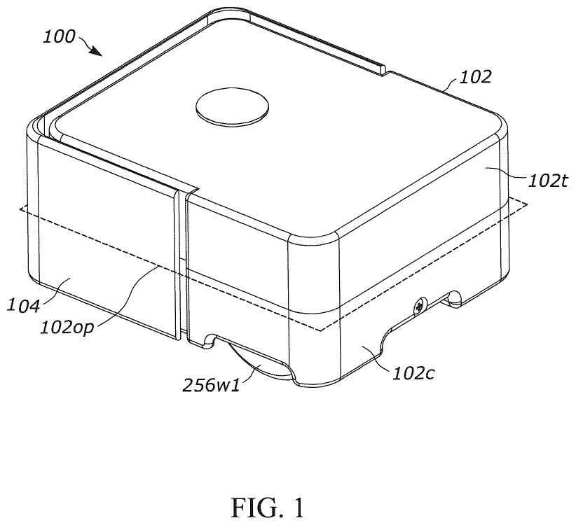

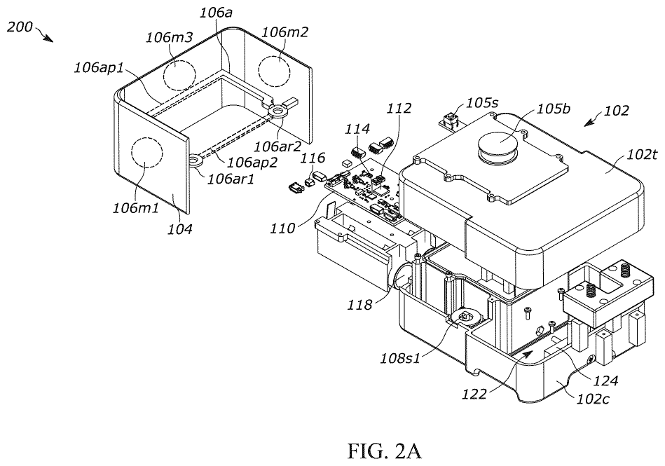

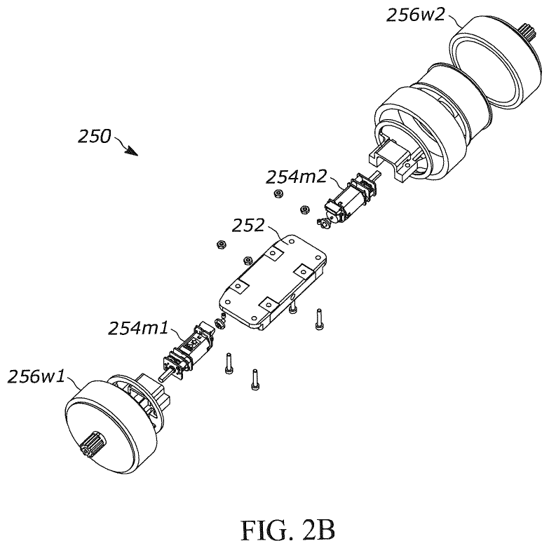

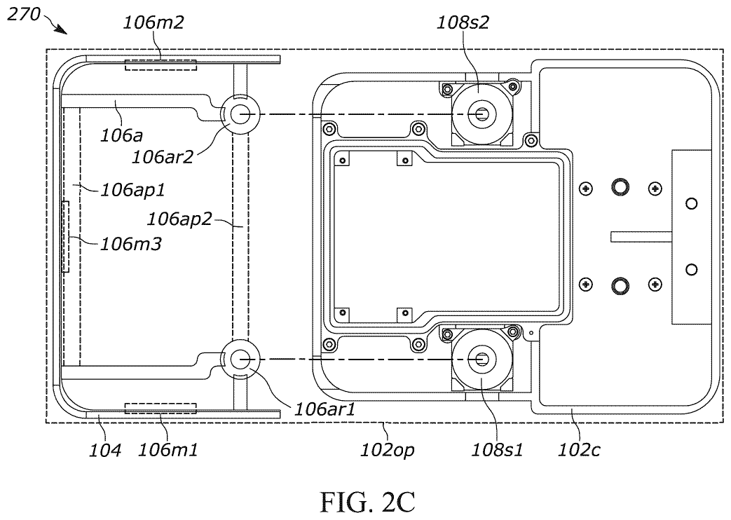

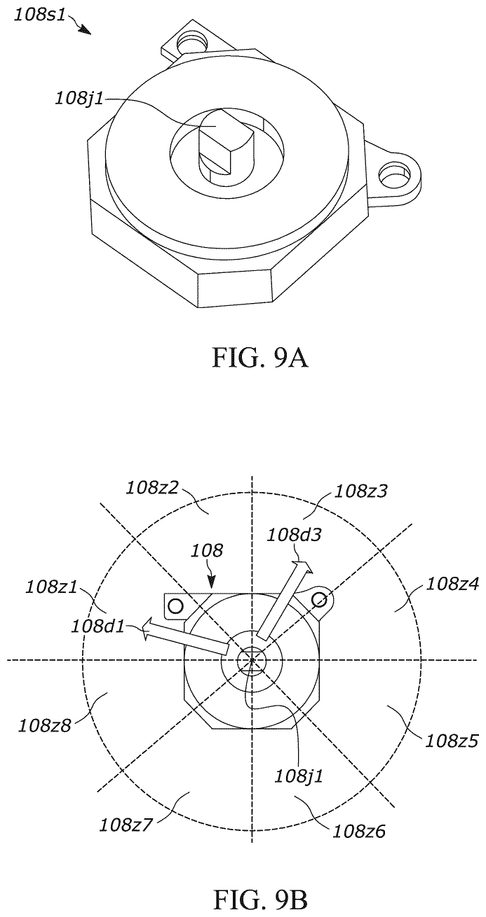

FIG. 1 illustrates a perspective view of an example robot 100 for cleaning or otherwise interacting with a space or environment in accordance with various aspects disclosed herein. As shown in the example of FIG. 1, the robot includes a body 102 comprising a chassis 102c and an outer perimeter 102op. In various aspects, the outer perimeter 102op may comprise or otherwise be formed of various aspects or components of body 102 of robot 100, which may include, by way of non-limiting example, bumper 104, chassis 102c (e.g., the lower portion of body 102), and/or top 102t of body 102. It is to be understood, however, that an outer perimeter (e.g., outer perimeter 102op) can include additional, less, and/or different components of a given robot body (e.g., body 102). More generally, an outer perimeter (e.g., outer perimeter 102op) defines an outermost region of robot 102 which can come into contact (e.g., bump or hit) objects within a cleaning environment (e.g., environment 800 as shown for FIG. 8). Still further, an outer perimeter (e.g., outer perimeter 102) may be formed of a material such as a hard plastic such as polyethylene, or otherwise a material that would otherwise prevent (or mitigate) damage or mark a surface when the outer perimeter 102op of robot 100 comes into contact with an object (e.g., a wall, baseboard, or furniture) within the environment in which robot 100 is moving or otherwise operating. Further, FIG. 1 illustrates wheel 256w1, which a first wheel of robot 100. Additional figures herein (e.g., FIG. 2B) further describe example wheels of the robot 100 herein.

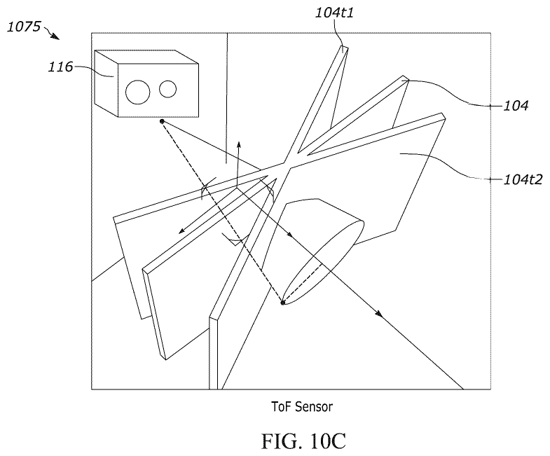

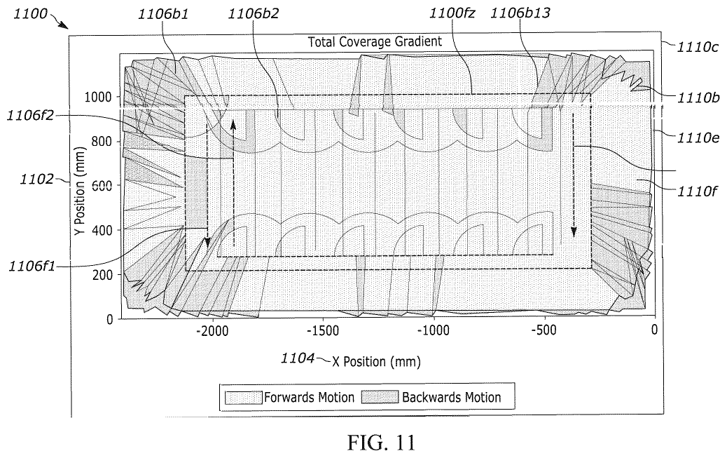

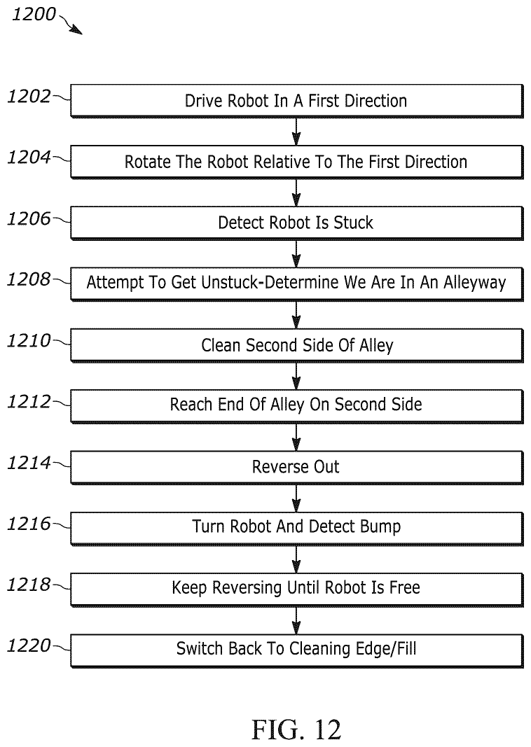

FIG. 2A illustrates an exploded view 200 of a portion of the example robot 100 of FIG. 1 in accordance with various aspects disclosed herein. In the example of FIG. 2A, body 102 of robot 100 is shown with its various components (but excluding wheels, which are further described herein with respect to additional figures, e.g., FIG. 2B). As shown for FIG. 2A, robot 100 comprises a bumper 104 configured to move relative to body 102 of robot 100. For example, bumper 104 may move towards body 102 of robot 100 when bumper 104 comes into contact with an object within an environment in which robot 100 is moving. In some aspects, bumper 104 comprises one or more magnets (e.g., any one or more of magnets 106m1, 106m2, and/or 106m3) positioned on, within, or partially within bumper 104. The magnets can be used to determine position of bumper 104 with respect to magnetic-based sensor(s) as described further herein, for example, with respect to FIG. 10A.

In further aspects, bumper 104 comprises an actuator (e.g., actuator 106a) configured to actuate one or more sensors (e.g., multi-directional sensors 108s1 and 108s2). Generally, an actuator (e.g., actuator 106a) is coupled to the one or more sensors (e.g., multi-directional sensors 108s1 and sensors 108s2) such that when bumper 104 comes into contact with an object in the environment, the actuator (e.g., actuator 106a) transfers force or otherwise provides information for detection by the one or more sensors (e.g., multi-directional sensors 108s1 and sensors 108s2). For example, when bumper 104 strikes an object, actuator 106a transfers force to multi-directional sensor 108s2 (e.g., as shown in FIG. 2C), where multi-directional sensor 108s2 is coupled to actuator 106a at actuator receiver 106ar2 (e.g., as shown in FIG. 2C). Similarly, when bumper 104 strikes an object actuator 106a transfers force to multi-directional sensor 108s1, where multi-directional sensor 108s1 is coupled to actuator 106a at actuator receiver 106ar1. The force transferred may comprise any directional force, including lateral, horizontal, and/or vertical, which may be sensed by a multi-directional sensor (e.g., multi-directional sensors 108s1 and sensors 108s2) of robot 100.

Further, in various aspects, actuator 106a may comprise various portions. For example, as shown for FIG. 2A actuator 106a may comprise portions 106ap1 and portions 106ap2, which are examples of cross arm or beam portions that, in some aspects, may form actuator 106a. The additional portions may transfer or distribute force to or among the various sensor(s) (e.g., multi-directional sensors 108s1 and sensors 108s2) thereby causing the sensor(s) to collect different data based on a location of the impact of a given object on bumper 104. For example, where actuator portion 106ap2 forms part of actuator 106a, an impact on bumper 104 nearer to actuator receiver 106ar2 would cause a greater amount of force to be transferred (across actuator portion 106ap2) to actuator receiver 106ar1. Thus, in such an example, multi-directional sensor 108s1 would sense or detect a greater degree of force (and thus generate a proportional degree of sensor data) than had actuator portion 106ap2 formed no part of actuator 106a.

As a further example, where actuator portion 106ap1 forms part of actuator 106a, an impact on a corner side of bumper 104 nearer to actuator receiver 106ar1 would cause a greater amount of force to transferred (across actuator portion 106ap1) to actuator receiver 106ar2. Thus, in such an example, multi-directional sensor 108s2 would sense or detect a greater degree of force data than had actuator portion 106ap1 formed no part of actuator 106a. It is to be understood, however, that additional, fewer, and/or different portions may be formed or otherwise configured for actuator 106a causing actuator receiver(s) (e.g., receiver 106ar1 and/or receiver 106ar2) to receive additional, fewer, and/or different force(s) thereby causing their respective sensors (e.g., multi-directional sensors 108s1 and sensors 108s2) to experience and detect different force or other data. In this way the sensor(s) and actuator(s) can be configured together to detect various fidelities, degrees, or otherwise types of sensor data to configure robot 100 to sense or respond to its environment and to navigate therein.

As further shown for FIG. 2A, a sensor multi-directional sensor (e.g., multi-directional sensors 108s1 and sensors 108s2) may be installed or otherwise position on body 102 for sensing, detecting, or otherwise receiving sensor data. The example embodiment of FIG. 2A illustrates multi-directional sensor 108s1 positioned on, in, or at partially within chassis 102c of robot body 102. Multi-directional sensor 108s2 is also positioned on chassis 102c as further shown for FIG. 2C herein. The multi-directional sensor(s) may fit or be otherwise be coupled to an actuator (e.g., actuator 106a of bumper 104) by receivers (e.g., receiver 106ar1 and/or receiver 106ar2) to receive and detect force or movement, and various degree(s) or otherwise amounts thereof. It is to be understood, however, that multi-directional sensor(s) may be positioned elsewhere on body 102 of robot 100. In some examples, one or more multi-directional sensor(s) may comprise Time-of-Flight sensor(s) where such sensor(s) may be positioned on a forward portion or other portion of robot 100.

Further with respect to FIG. 2A, robot 100 comprises a circuit board 110. Battery 118 may power circuit board 110 and its various components, which may include, by way of non-limiting example, a processor 112 and a memory 114. Processor 112 may be communicatively coupled to memory 114 via a computing bus of circuit board 110. Further, Processor 112 may be communicatively coupled to the multi-directional sensor(s) (e.g., multi-directional sensors 108s1 and sensors 108s2) for receiving sensor data from the sensor(s). Processor 112 may transfer to (e.g., store), and receive (e.g., load) from memory 114 information, including computing instructions and/or data (e.g., sensor data). For example, in various aspects, memory 114 comprises a computer memory storing computing instructions (e.g., firmware) on the computer memory for execution by processor 112. Processor 112 may receive sensor data from multi-directional sensor(s) (e.g., multi-directional sensors 108s1 and sensors 108s2), where computing instructions, loaded from memory 114, cause processor 112 to analyze the sensor data causing robot 100 to implement any of the algorithms, methods, processes, steps, and/or otherwise functionality describe herein. For example, the computing instructions may cause robot 100 to navigate in an environment, respond to objects or series of objects within the environment and/or surface types (e.g., different variations in surfaces or types thereof caused by a vent, register, or other such item causing a surface irregularity or difference in a floor area that the robot is operating with respect to), including processing or otherwise interpreting sensor data to determine how to operate when the robot, or portion thereof, comes into contact with an object within the environment. In various aspects, the computing instructions may be implemented in any desired program language (e.g., C, C++, C#, C, Java, or the like), and may be interpreted or executed as program code, machine code, assembly code, byte code, or the like.

Circuit board 110 may further comprise a Time-of-Flight (ToF) sensor 116 that may be positioned to scan, image, or detect an interior surface of robot 100, such as the interior surface of bumper 104. The ToF sensor 116 may scan the bumper 104 surface several times per second to determine a distance or magnitude of travel of the surface of bumper 104 for the purpose of detecting, e.g., via a degree of travel or movement of the bumper surface, an impact on the bumper 104 by an obstacle in an environment in which the robot 100 moves.

FIG. 2A further illustrates a cavity 122 which comprises a wheel well for housing a wheel structure as illustrated for FIG. 2B. The wheel structure may be attached by pivot plate 124 for pivoting the wheel structure or otherwise allowing the wheels structure to move, dampen, and/or respond to floor surface(s) and/or obstacles.

Robot 100 may further comprise a button 105b that when depressed activates a switch 105s. Switch 105s may be communicatively coupled to processor 112, such that when pressed, sends a single causing processor 112 to perform various functions, including turning a state of the robot on, off, cycling through various modes of operation of the robot, and/or otherwise implementing any of the algorithms, flowcharts, or instructions as described herein.

FIG. 2B illustrates a further exploded view 250 of the example robot 100 of FIG. 1 in accordance with various aspects disclosed herein. In the example of FIG. 2B, wheels of robot 100 are shown with various components. These components are configured to fit or otherwise be installed into cavity 122 of robot 100 and attached to pivot plate 124, as described herein for FIG. 2A. For example, the wheel structure as shown for FIG. 2A may comprise a wheelbase 252 configured to receive (e.g., via screws) motor 254m1 and motor 254m2. Each of motors 254m1 and 254m2 may couple to (e.g., be positioned within or partially within) wheels 256w1 and 256w2. Each of motors 254m1 and 254m2 may comprise electric motors (e.g., a 12-volt direct current (DC) motor) that may comprise a gearbox and/or shaft(s) for rotating a turning a wheel or tire, e.g., via a cogged base wheel, such as shown for each of wheels 256w1 and 256w2. By way of non-limiting example, motors 254m1 and 254m2 may be brush or brushless motor(s) having gear assemblies and electronics for rotating the wheels when a power source is applied (e.g., battery 118). It is to be understood, however, that additional, fewer, and/or different motor(s) or types thereof may be used to move or drive robot 100.

Wheelbase 252 as shown for FIG. 2A may be attached (e.g., via screw(s)) to pivot plate 124 of robot 100 allowing the wheelbase (e.g., and thus wheels 256w1 and 256w2) to tilt and/or pivot, which allows the wheel structure, as a whole, to respond to a floor surface and/or variances thereof (caused by a non-level floor, bumps, etc.) of an environment by absorbing shock or conforming to the floor or otherwise variance.

As shown for FIG. 2B, motor 254m1 and motor 254m2 may be coupled to wheel 256w1 and wheel 256w2 respectively. Motor 254m1 is configured to drive or rotate wheel 256w1 forward and backward. Likewise, motor 254m2 is configured to drive or rotate wheel 256w2 forward and backward. Processor 112 may be communicatively coupled to each of the motor(s) to send signals to cause the motors to drive, actuate, or otherwise move robot 100 in various directions or manners (e.g., forward, backward, rotating, etc.) within a given environment.

FIG. 2C illustrates a top-down cross-sectional view 270 of the example robot of FIG. 1 in accordance with various aspects disclosed herein. Robot 100 comprises an example robotic configuration comprising two sensors, that is, a first sensor and a second sensor, which may each comprise multi-directional sensors as shown embedded or at least partially within chassis 102c. In particular, as illustrated for FIG. 2C, robot 100 includes multi-directional sensor 108s1 and multi-directional sensor 108s2. In various aspects, processor 112 may execute computing instructions, stored in memory 114, that when executed by the processor, cause processor 112 to receive first sensor data from multi-directional sensor 108s1 and/or second sensor data from multi-directional sensor 108s2 when at least a portion (e.g., bumper 104) of the outer perimeter (e.g., outer perimeter 102op) of the body 102 contacts an object (e.g., obstacle 804) in a given environment (e.g., environment 800). The first and/or second sensor data may be analyzed by processor 112, which may respond by actuating a motor (e.g., motor 254m1 and/or motor 254m2) based on the first and/or second sensor data to cause the robot to alter its course in the environment (e.g., example environment 800) in order to navigate or traverse the obstacle (e.g., obstacle 804).

In the example of FIG. 2C, each of multi-directional sensor 108s1 and multi-directional sensor 108s2 are coupled to at least a portion of the outer perimeter 102op via a multi-axis sensor actuator (e.g., actuator 106a). More generally, a given sensor (e.g., multi-directional sensor 108s1 and/or multi-directional sensor 108s2) may be coupled to a portion of the robot (e.g., bumper 104) that forms an outer perimeter thereof. In various aspects, a multi-axis sensor actuator (e.g., actuator 106a) is a structure that moves or otherwise actuates the sensors(s) (e.g., multi-directional sensor 108s1 and/or multi-directional sensor 108s2). In some aspects, the multi-axis sensor actuator (e.g., actuator 106a) is a dampening structure, which may be formed of one or more areas, portions, or frame types. For example, the multi-axis sensor actuator (e.g., actuator 106a) is shown with various example portions 106ap1 and 106ap2, which may or may not form part of the multi-axis sensor actuator (e.g., actuator 106a). The additional portions 106ap1 and/or 106ap2 may be added or removed to the multi-axis sensor actuator (e.g., actuator 106a) so as to provide different force(s) across the physical structure of actuator 106a as a whole. For example, adding portion 106ap1 and/or 106ap2 can cause sensors (e.g., multi-directional sensor 108s1 and/or multi-directional sensor 108s2) to experience additional force when the force is transferred from bumper 104 (after striking an object) across portion(s) 106ap1 and/or 106ap2 to respective actuator receiver 106ar1 and/or actuator receiver 106ar2, and ultimately to respective sensors (e.g., multi-directional multi-sensor 108s1 and/or multi-directional sensor 108s2) for generation of corresponding sensor data.

Still further, the material properties of the multi-axis sensor actuator (e.g., actuator 106a) and/or its portions(s) 106ap1 and/or 106ap2 may impact or otherwise influence the amount or degree of force, and thus, amount or degree of sensor data, generated by the sensor(s). That is, in various aspects the multi-axis sensor actuator 106a (and/or portions thereof) may be configured to be deformed in a shape such that a deformation of the shape can create a change in sensor data as output by at least one sensor (e.g., multi-directional sensor 108s1 and/or multi-directional sensor 108s2). For example, a dampening effect of a given dampening structure come from the physical material (e.g., plastic) of the multi-axis sensor actuator itself where the property of plastic(s) and the deformation behavior of plastics in general may, at least in some aspects, provide dampening and/or elasticity. It is to be understood that the multi-axis sensor actuator need not be perfectly clastic. In various aspects, the multi-axis sensor actuator can be rigid or flexible. Additionally, or alternatively, the multi-axis sensor actuator (e.g., actuator 106a) can be linear or non-linear with respect to flexibility, but at the same time be configured to actuate one or more sensor(s). For example, the multi-axis sensor actuator (e.g., actuator 106a) as a dampening structure may be coupled to multi-directional sensor 108s1 and second multi-directional sensor 108s2 but be configured to be sufficiently rigid to move multi-directional sensor 108s1 and/or multi-directional sensor 108s2 when a force is applied to the multi-axis sensor actuator (e.g., actuator 106a). Such force may comprise when at least a portion of the outer perimeter (e.g., outer perimeter 102op) of body 102 of robot 100 contacts an object (e.g., obstacle 804) in the environment (e.g., environment 800). For example, in some aspects, the multi-axis sensor actuator (e.g., actuator 106a) is formed of a material (e.g., a plastic) that is sufficiently rigid to apply actuation force(s) to one or more of the sensor(s) (e.g., multi-directional sensor 108s1 and/or the second multi-directional sensor 108s2) so as to apply a degree of force in proportion to the sensor(s) in order to move, or otherwise interact with, the sensor(s) and thus cause sensor data to be generated therefrom.

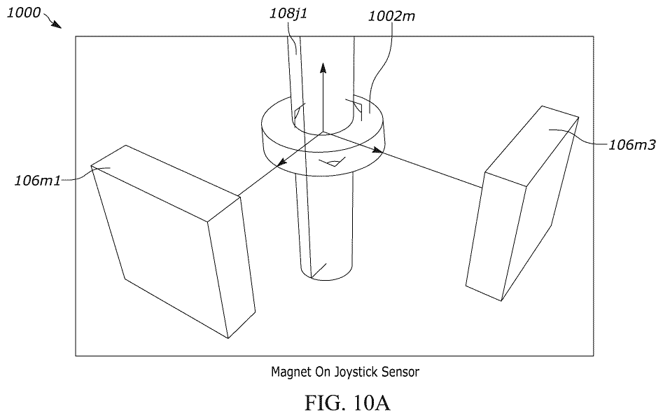

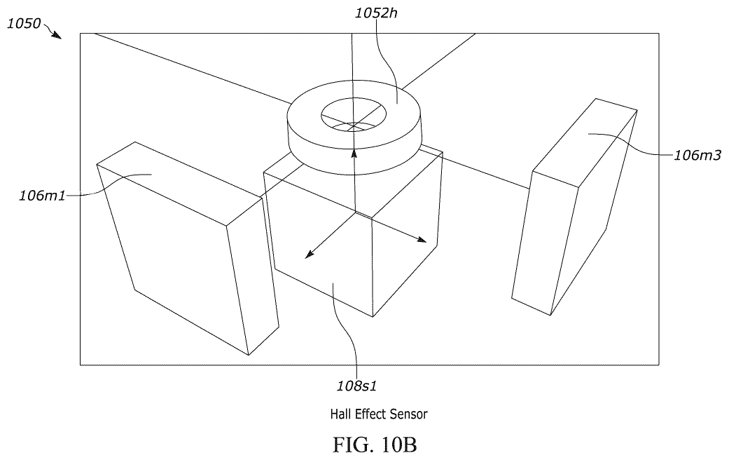

In the example of FIG. 2C, multi-directional sensor 108s1 and/or multi-directional sensor 108s2 may comprise joystick type sensors that generate respective sensor data when force is applied to a joystick (e.g., 108j1 as shown for FIG. 9A) of the sensor. For example, a joystick (e.g., joystick 108j1) of multi-directional sensor 108s1 may connect or otherwise couple to actuator receiver 106ar1, where actuator receiver 106ar1 pushes or otherwise actuates the joystick portion of multi-directional sensor 108s1 when bumper 104 hits an object in an environment (e.g., example environment 800). Actuation of the joystick sensor (or otherwise multi-directional sensor 108s1) causes the sensor to generate sensor data (e.g., in a degree proportional to the amount of travel of the joystick) that is then provided to processor 112 and/or 114 for processing, analysis, and/or storage, for example, as described herein. In some aspects, multi-directional sensor 108s2 may also be a joystick sensor that operates in as same or similar manner as described for multi-directional sensor 108s1.

In various aspects, each of the multi-axis sensor actuator (e.g., 106a), multi-directional sensor 108s1, and multi-directional sensor 108s2 together comprise or form a synthetic sensor. In such aspects, computing instructions stored on the computer memory 114, when executed by processor 112, are configured to cause processor 112 to generate synthetic sensor data based on first sensor data of as received by multi-directional sensor 108s1 and/or second sensor data as received by multi-directional sensor 108s2. For example, in some aspects, synthetic sensor data may comprise data computed and/or combined using each of the first sensor data and the second sensor data even though the sensor data and the second sensor data may differ based on at least one of direction and/or magnitude. Synthetic sensor data may be calculated, generated, or otherwise determined by averaging, taking a derivative of, taking weights of, or otherwise combining the first sensor data and the second sensor data of multi-directional sensor 108s1 and multi-directional sensor 108s2. Such data may be generated when the sensor(s) are actuated as part of multi-axis sensor actuator (e.g., 106a) when robot 100 (e.g., bumper 104) strikes an object (e.g., obstacle 804).

In addition, in some aspects multi-axis sensor actuators (e.g., actuator 106a) are configured to actuate separate sensor(s) separately or independently. For example, actuator 106a could be configured to actuate multi-directional sensor 108s1 and/or multi-directional sensor 108s2 separately or independently by disassociating or otherwise eliminating portions (e.g., actuator portion 106ap1 and/or actuator portion 106ap2) of the bumper 104. For example, in some aspects, bumper 104 may be configured to have multiple independent portions that move freely with respect to one another and thus separately actuate related sensor(s) that are coupled to respective actuator receiver(s).

Still further, additionally or alternatively, in some aspects, multi-axis sensor actuator (e.g., actuator 106a and portions thereof such as actuator portion 106ap1 and/or actuator portion 106ap2) is limited to one more directions and/or one or more distances of travel within or with respect to the body 102 of robot 100 to prevent actuating at least one of the multi-directional sensor (e.g., multi-directional sensor 108s1) or the second multi-directional sensor (e.g., multi-directional sensor 108s2) to a fully actuated position. For example, in such aspects, by preventing or avoiding actuating a multi-directional sensor to a fully actuated position, the longevity and/or operation of the multi-direction sensor, as well as its data fidelity, may be improved, thereby improving and/or prolonging the accuracy and operating efficiency of the robot itself.

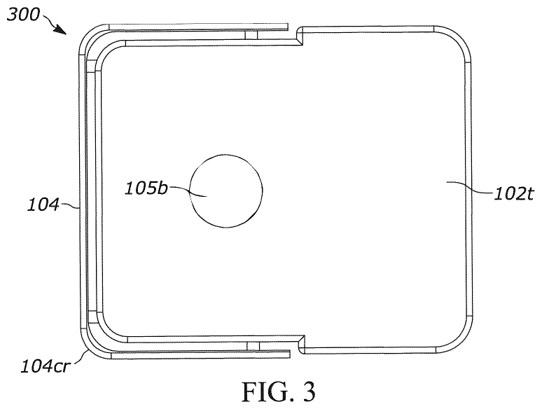

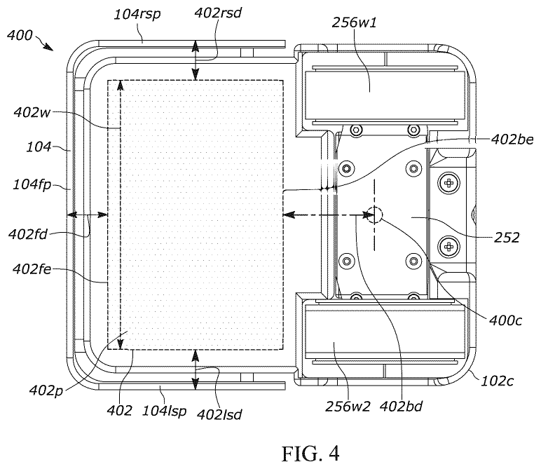

FIG. 3 illustrates a top view 300 of the example robot 100 of FIG. 1 in accordance with various aspects disclosed herein. FIG. 3 illustrates bumper 104 and top 102t of body 102 of robot 100 as viewed from above. The bumper 104 may be comprised of a corner radius (e.g., corner radius 104cr) configured to maximize, or least enlarge, an area of the cleaning element (e.g., cleaning element 402 as described for FIG. 4).

FIG. 4 illustrates a bottom view 400 of the example robot of FIG. 1 in accordance with various aspects disclosed herein. FIG. 4 illustrates bumper 104 and chassis 102c of body 102 of robot 100 as viewed from below. Further, FIG. 4 illustrates wheelbase 252 as well as wheels 256w1 and wheels 256w1 as viewed from below. Still further, FIG. 4 illustrates a cleaning element 402 that may be attached to body 102 of robot 100. Such cleaning element may comprise a substate mount (e.g., a VELCRO-based mount or a grommet-based mount) for receiving and holding a disposable hard surface wiping substate (e.g., cleaning pad 402p) to the underside of robot 100. The cleaning element 402 or substate mount may include a width (e.g., width 402w). Cleaning element 402 may be used to vacuum, sweep, disinfect, and/or apply a cleaning solution to the floor as robot 100 moves within an environment (e.g., environment 800). At least in one non-limiting example, cleaning element 402 may comprise, otherwise be configured to fit, a SWIFFER brand cleaning element or pad (e.g., as represented by cleaning pad 402p), including variants thereof, as manufactured or provided by THE PROCTER & GAMBLE COMPANY (P&G).

Still further, with respect to FIG. 4, the robot may comprise a center of rotation (e.g., center of rotation 400c). The robot may further comprise a turn radius, which can be measured based on a distance (e.g., distance 402bd) between a back edge of a portion (e.g., back edge 402be) of cleaning element 402 (e.g., the back edge cleaning pad 402p attached to or as part of cleaning element 402) and the center of rotation (e.g., center of rotation 400c).

In addition, as shown for FIG. 4, bumper 104 comprises a front bumper portion 104fp, a right-side bumper portion 104rsp, and a left-side bumper portion 104lsp. It is to be understood that additional and/or different bumper portions, areas, or zones may be defined for bumper 104.

Further, as shown for FIG. 4, cleaning element 402, or a portion thereof (e.g., a cleaning pad) may be positioned in proximity to bumper 104. As shown, front side bumper distance 402fd is a distance between front bumper portion 104fp and a front edge 402fe of cleaning element 402, or a portion thereof (e.g., a cleaning pad). Similarly, right side bumper distance 402rsd is a distance between right bumper portion 104rsp and a right-side edge of cleaning element 402, or a portion thereof (e.g., a cleaning pad). Further, left side bumper distance 402lsd is a distance between left bumper portion 104lsp and a left-side edge of cleaning element 402, or a portion thereof (e.g., a cleaning pad).

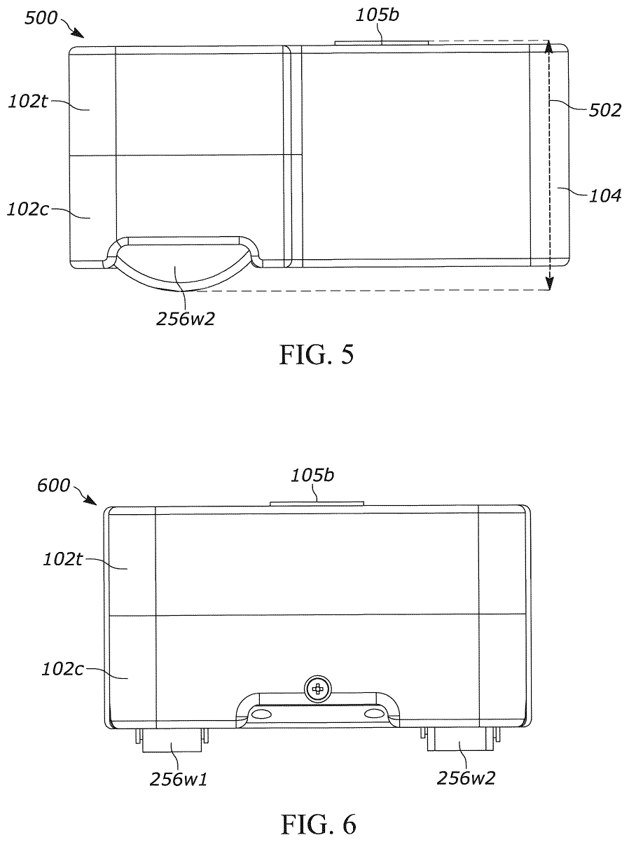

FIG. 5 illustrates a side view 500 of the example robot of FIG. 1 in accordance with various aspects disclosed herein. FIG. 5 illustrates bumper 104, chassis 102c and top 102t of body 102, and wheel 256w2 as viewed from a side of robot 100. The robot 100 may comprise a height 502, which may be measured from a bottom of a wheel (e.g., wheel 256w2) to a top portion of the robot 100.

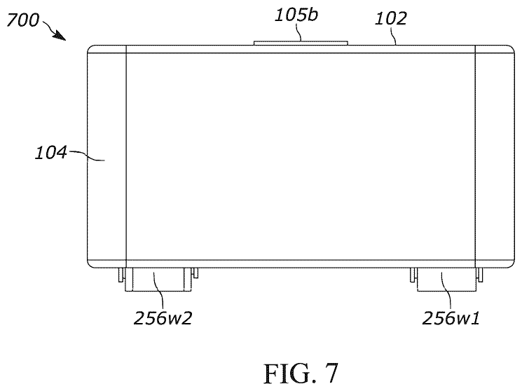

FIG. 6 illustrates a rear view 600 of the example robot 100 of FIG. 1 in accordance with various aspects disclosed herein. FIG. 6 illustrates chassis 102c and top 102t of body 102, as well as wheels 256w1 and 256w2 as viewed from the rear of robot 100.

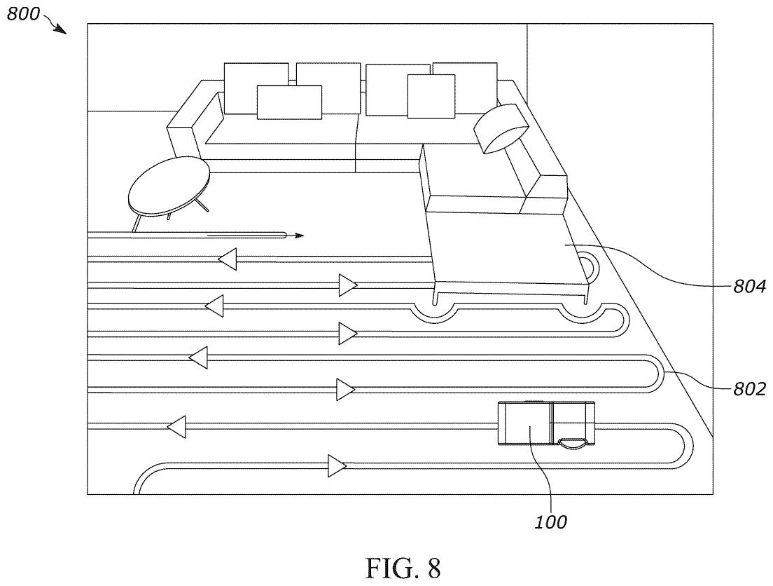

FIG. 7 illustrates a front view of the example robot 100 of FIG. 1 in accordance with various aspects disclosed herein. FIG. 7 illustrates bumper 104 as well as wheels 256w1 and 256w2 as viewed from the front of robot 100.

FIG. 8 illustrates an example environment 800 in which the robot of FIG. I can navigate or otherwise move within in accordance with various aspects disclosed herein. Environment 800 illustrates an example room (e.g., a living room) comprising an obstacle 804 (e.g., furniture) having two portions (e.g., legs) around which robot 100 must navigate or move. As shown in the example of figure, robot is programmed to move in linear forward back-and-forth motion to clean environment 800. As the robot encounters obstacle 804, robot 100 can navigate accordingly. For example, bumper 104 may come into contact with obstacle 804 (e.g., furniture) causing force to be detected by sensor(s) (e.g., multi-directional sensors 108s1 and 108s2). Sensor data may be sent to processor 112, which executes computing instructions to drive wheels of robot (e.g., wheels 256w1 and/or 256w2) to operate robot to move around or otherwise traverse obstacle 804 to allow robot 100 to continue its forward navigation, and therefore cleaning of environment 800.

### Robotic Sensor Control

FIG. 9A illustrates an example multi-directional sensor (e.g., multi-directional sensor 108s1) in accordance with various aspects disclosed herein. In the example of FIG. 9A, multi-directional sensor is an analog sensor, such as a joystick sensor. It is to be understood, that multi-directional sensor 108s1 may, in other aspects, comprise a different type of sensor, for example as described herein. As shown for FIG. 9A, multi-directional sensor (e.g., multi-directional sensor 108s1) comprises a joystick 108j1 that when moved or otherwise actuated, causes multi-directional sensor 108s1 to generate sensor data to a degree and/or magnitude associated with a distance and/or direction of travel of the joystick 108j1. For example, in various aspects, when joystick 108j1 is moved or otherwise actuated by actuator 106a through actuator receiver 106ar1, multi-directional sensor 108s1 generates sensor data. Processor 112 receives the sensor data from the multi-directional sensor 108s1. This can occur, for example, when at least a portion of the outer perimeter of the body of the robot contacts an object in an environment (e.g., environment 800). Processor 112, analyzing the sensor data, can then actuate the motor (e.g., motor 254m1 and or motor 254m2). Because the sensor data differs based on the degree of travel of the joystick (or degree of difference in the change based on the sensor type), the sensor data comprises high fidelity sensor data that can be used measure (e.g., based on the degree of travel of the joystick) various proportional degrees of contact or otherwise interactions with obstacles in the environment 800. Such high-fidelity data allows processor 112 of robot 100 to maneuver, alter its course, or otherwise operate in highly sensitive and/or highly specific manners for cleaning in small spaces, spaces having low angled areas, tight corners, or the like. The high-fidelity sensor data allows, for example, the robot to maneuver its cleaning element 402 (e.g., comprising cleaning pad) into and/or up to boundary edges (e.g., walls or otherwise edges) of an environment. At the same time, the high-fidelity sensor data allows for the robot to be operated so as to have a low impact (e.g., gentle interaction) with obstacles or walls in the environment (e.g., to avoid damaging the obstacle when it is struck by the robot). This could include, for example, precluding or mitigating damage to paint on baseboards, wood on furniture legs, etc.

Still further, in some aspects, a sensor (e.g., multi-directional sensor 108s1) may be limited to one more directions of travel and/or one or more distances of travel within or with respect to the body of the robot 100 to prevent a sensor or portion thereof (e.g., joystick 108j1) to move to a fully actuated position. That is, a joystick or otherwise high-fidelity sensor portion, may be prevented, e.g., by an actuator (e.g., actuator 106a as described herein) from traveling to the joystick's maximum physical distance. Travel to a maximum distance may place stress on the sensor or its components (e.g., springs in the joystick sensor). By preventing or avoiding actuating a multi-directional sensor to a fully actuated position, the longevity and/or operation of the sensor, as well as its data fidelity, may be improved or extended, thereby improving and/or prolonging the accuracy and operating efficiency of the robot itself.

FIG. 9B illustrates the example multi-directional sensor of FIG. 9A with an example plurality or set of radial zones (e.g., zones 108z1-108z8) in accordance with various aspects disclosed herein. Generally, sensor data may be analog or otherwise raw sensor data that does not define discrete or otherwise digital-based directions. FIG. 9B illustrates that, at least in some aspects, the sensor data may be formatted, augmented, defined or otherwise determined as directional sensor data that indicates discrete or otherwise zone-based direction(s) in which a multi-directional sensor was actuated towards or with respect to. Each radial zone can then be used to define a given direction relative to the robot 100.

As shown for FIG. 9B, multi-directional sensor 108s1 comprises eight (8) discrete zones (e.g., zones 108z1-108z8). It is to be understood, however, that additional, fewer, or different zones may also be utilized. For example, in one aspect, the plurality of radial zones may comprise at least two radial zones. Still further, in some aspects, the plurality of radial zones are configurable or otherwise adaptable to have a specified number of radial zones (e.g., 16 or 32 zones), where an increase in zones allows the sensor to report or otherwise determine a higher degree of zone activity defining the position of joystick 108j1 and thus allowing robot 100 more finite and discrete control within an environment (e.g., environment 800). Still further, in some aspects, such zones need not be uniform in size(s) and/or degree(s). Additionally, or alternatively, such zones need not be radial but can be configured to have or otherwise comprise different shapes or patterns.

When joystick 108j1 is at rest (i.e., not actuated) then a multi-directional sensor(s) can provide sensor data reporting a zero-position. In some aspects, the zero-position is set by the robot 100 when it powers on, where the robot determines an initial position of the multi-directional sensor (e.g., when at rest) as constituting the zero-position. Such procedure can be performed for each power cycle of the robot 100 (e.g., when the robot 100 is turned on and off). When 108j1 is moved in a given direction (e.g., direction 108d1) then multi-directional sensor 108s1 can provide, report, or send sensor data to processor 112 for analysis. Processor 112 can then execute its computing instructions to determine which zone the sensor data belongs to, e.g., zone 108z1 for direction 108d1. As a further example, when 108j1 is moved in direction 108d3 then multi-directional sensor 108s1 can provide, report, or send sensor data to processor 112 for analysis, where processor 112 can execute its computing instructions to determine that the sensor data belongs to zone 108z3. In this way, processor 112 can determine whether sensor data belongs to any of the given zones (e.g., zones 108z1-108z8). Such zone information and/or determination can then be used to drive or otherwise manipulate the robot 100 (e.g., by moving the robot 100 in environment 800).

Further, for each sensor, the sensor's respective sensor data can be based on the sensor's location relative to the robot 100 and/or it's body 102. For example, multi-directional sensor 108s1 may be located on a side of the robot, where processor 112 executes programming instructions that factor in multi-directional sensors 108s1's position relative to the robot 100 and/or it's body 102, in addition to other factors, such as actuator 106a's impact on multi-directional sensor 108s1 based on the position of actuator 106a (and/or its portions), the material propertie(s) of actuator 106a, and/or the direction of travel of joystick 108j1 based on such impact, configuration, structure, or otherwise setup of the overall mechanism of these components relative to multi-directional sensors 108s1.

FIGS. 10A-10C illustrate example sensors that may be used in addition to, or in the alternative to, the analog and/or joystick sensors as described for FIGS. 9A and 9B herein.

FIG. 10A illustrates an example magnetic-based multi-directional sensor configuration 1000 in accordance with various aspects disclosed herein. In the example of FIG. 10A, the multi-directional sensor is configured such that a magnet 1002m is attached to joystick 108j1 of multi-directional sensor 108s1. In such aspects, multi-directional sensor 108s1 comprises a magnetic field sensor such that one or more magnets (e.g., magnets 106m1-106m3) are positioned on the outer perimeter 102op (e.g., bumper 104) of robot 100 to provide magnetic signals. In such aspects, the magnetic field sensor (e.g., multi-directional sensor 108s1) of magnetic-based multi-directional sensor configuration 1000 generates the sensor data based on the magnetic signals provided by the one or more magnets (e.g., magnets 106m1-106m3) when an object strikes the outer perimeter 102op (e.g., bumper 104) of robot 100. For example, as shown for FIGS. 2A and 2C, magnets 106m1-106m3 are positioned on a surface (e.g., an interior surface or partially embedded surface of bumper 104) of the robot 100 to provide magnetic signals such that the magnets travel closer or further from the joystick 108j1 and magnet 1002m as bumper 104 is struck by a given object. The magnetic field sensor (e.g., multi-directional sensor 108s1) can then generate sensor data, for receipt by processor 112, based on the magnetic signals. More generally, the magnets that make up the magnetic field can be positioned on robot 100 in various locations, e.g., the magnetic field sensor could be on or in the body of the robot with the magnets on the outer perimeter 102op of the robot body (e.g., magnets on bumper 104 as illustrated for FIG. 2A), or, in the alternative, the magnetic field sensor could be on the bumper structure, with the magnets inside the robot body 102 (not shown).

FIG. 10B illustrates an example Hall-effect-based multi-directional sensor configuration 1050 in accordance with various aspects disclosed herein. As shown in FIG. 10B, a multi-directional sensor 108s1 may comprise a Hall-effect type sensor. Generally, a Hall-effect sensor (e.g., multi-directional sensor 108s1) of Hall-effect-based multi-directional sensor configuration 1050 may comprise a type of transducer configured to detect the presence or absence of a magnetic field. The magnetic field can be created by one or more magnets (e.g., magnets 106m1-106m3) that are positioned on the outer perimeter 102op (e.g., bumper 104) of robot 100 to provide magnetic multi-directional sensor 108s1 may detect the generation of a voltage difference (i.e., a Hall voltage) across a conductor or semiconductor of multi-directional sensor 108s1 when it is subjected to the magnetic field. The voltage is proportional to the strength of the magnetic field and can be measured as an output signal. The output signal may comprise (e.g., can be interpreted as, or cause to be generated) sensor data that can be provided to processor 112 for analysis and processing to move or navigate robot 100 as described herein.

FIG. 10C illustrates an example Time-of-Flight (ToF)-based multi-directional sensor configuration 1075 in accordance with various aspects disclosed herein. FIG. 10C illustrates ToF sensor 116 as a multi-directional sensor. ToF sensor 116 measures the distance between ToF sensor 116 and an object (e.g., bumper 104) by determining the time it takes for a light signal or a laser pulse to travel to the object and back to the sensor. More generally, a TOF sensor operates based on the principle of measuring the time it takes for light to travel a certain distance. A given ToF sensor will emit a light signal, such as a laser pulse or an infrared beam, and then measure the time it takes for the signal to be reflected back to the sensor. By using the known value of the speed of light, a ToF sensor (e.g., ToF sensor 116) can calculate the distance to the object. ToF sensor 116 can then use the information regarding the reflected light to generate 3D sensor data defining the object that the light was reflected off of.

As shown for FIG. 10C, multi-directional sensor 116 is configured to send and receive signals (e.g., such as light represented by field of view cone) to an interior surface of robot 100 (e.g., bumper 104). The surface (e.g., bumper 104) may change angles or otherwise be deformed when it comes into contact with an object (e.g., obstacle 804) of an environment (e.g., environment 800). For example, surface 104t1 represents a surface of bumper 104 at a first time and surface 104t2 represents a surface of bumper 104 at a second time when bumper 104 is being moved or otherwise deformed when robot 100 strikes an object (e.g., obstacle 804). The ToF sensor 116 can detect light bounced off bumper 104 and generate 3D sensor data associated with the amount and direction of the movement or deformation of bumper 104. Such 3D sensor data can then be provided to processor 112 for processing and/or analysis described herein. That is, in some aspects, sensor data comprises three-dimensional (3D) sensor data as detected and generated by a ToF sensor (e.g., ToF sensor 116) of one or more interior surfaces of the body of the robot (e.g., one or more interior surfaces of bumper 104). In such aspects, the 3D sensor data can define a distance of the one or more interior surfaces of the body of the robot with respect to the ToF sensor that processor 112 can use to determine an impact or movement of the given surface area, and then move or navigate robot 100 in response thereto.

### Robot Navigation Strategies

Robotic cleaning may comprise navigation strategies implemented by a robot (e.g., robot 100) executing algorithms or computing instructions stored in its memory (e.g., memory 114). In various aspects, a robot configured for cleaning and/or navigation comprises a body (e.g., robot body 102) having a chassis (e.g., chassis 102c) and a cleaning element (e.g., cleaning element 402). The robot may comprise a motor (e.g., motor 254m1 and/or motor 254m2) configured to move the robot (e.g., robot 100) within an environment (e.g., environment 800).

The robot may further comprise a sensor. The sensor may include a force-based sensor (e.g., an analog sensor or a joystick sensor as described herein for FIG. 9A and/or 10A). However, it is to be understood, that the sensor may comprise a different sensor type including, by way of non-limiting example, a magnetic-based sensor (e.g., a magnetic field or Hall-effect sensor as described herein for FIGS. 10A and 10B). Additionally, or alternately, the sensor may comprise an image-based sensor or light-based sensor (e.g., ToF sensor 116) as described herein for FIG. 10C.

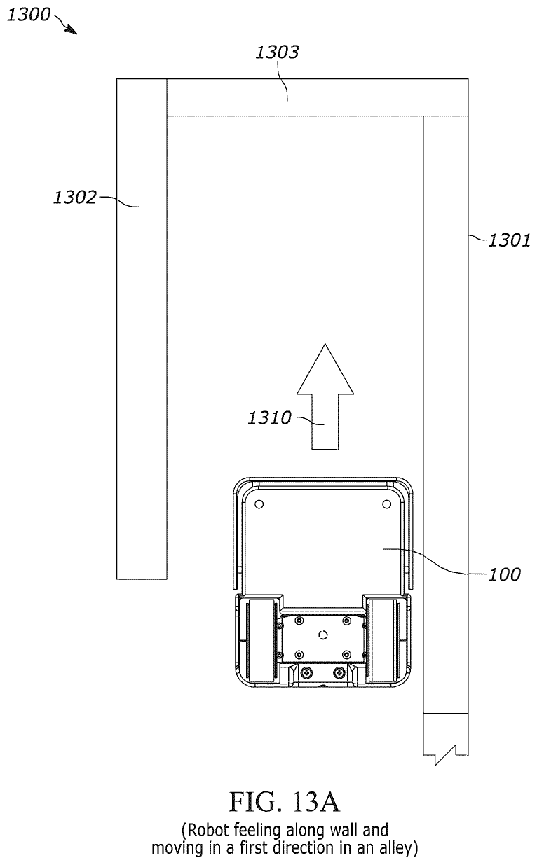

The robot may further comprise a processor (e.g., processor 112) communicatively coupled to the sensor and a computer memory (e.g., memory 114) communicatively coupled to the processor. The computing instructions, when executed by the processor (e.g., processor 112), may cause the processor to navigate or alter the course of the robot within the environment (e.g., environment 800), for example, as described herein for FIGS. 11-16. The maneuvering, altering of course, or otherwise navigation strategy increases cleaning efficiency by minimizing particle drop (i.e., debris falloff) because the robot is configured to maintain or maximize a forward movement or forward moving direction. The forward movement or forward moving direction allows the cleaning element 402 (e.g., its cleaning pad) to capture and push debris in a continuous direction so as to hold the debris in the pad (e.g., cleaning pad 402p). Similarly, the navigation strategy minimizes any reverse movement or reverse direction to prevent or minimize backing up or reversing direction, which can cause the cleaning element 402 (e.g., comprising its cleaning pad 402p) to experience debris falloff or particle drop.

FIG. 11 illustrates a coverage diagram 1100 showing example navigation or movement of a robot (e.g., robot 100) within an environment in accordance with various aspects disclosed herein. In particular, FIG. 11 shows coverage plot or diagram showing a path that a robot (e.g., robot 100) moved or navigated within a given environment. For example, the environment may comprise or represent a top-down view of environment 800. In various aspects, including in the example of FIG. 11, the robot (e.g., robot 100) operates in different modes related to cleaning different areas of an environment 800. For example, a robot (e.g., robot 100) may operate to clean one or more edge(s) (e.g., walls) of an environment 800 as demonstrated, for example, by forward movement 1110f. As a further example, a robot (e.g., robot 100) may operate to clean a fill zone 1100fz, which may comprise a non-edge area of an environment (e.g., a center or middle area of an environment 800), which may be represented, for example, by areas shown for forward movements of the robot (e.g., forward movements 1106f1-1106f13).

In the example of FIG. 11, the environment is defined or mapped according to a Y-Position 1102 and an X-Position 1104 defining the robot's movement within the environment 800. The positions are measured in millimeters (mm), although it is to be understood that different position values and/or measurements may be used to identify a robot's position within a given environment.

As demonstrated in the example of FIG. 11, robot 100 moves, at least in one aspect, in a zig-zag type pattern, or, otherwise back-and-forth type pattern comprising forward movement 1106f1, forward movement 1106f2, and so forth including forward movement 1106f13. It is to be understood, however, that different movement patterns are contemplated herein. Each of the forward movements (e.g., forward movements 1106f1-1106f13) comprises a forward direction or otherwise forward motion relative to a cleaning element (e.g., cleaning element 402) of the robot (e.g., robot 100), where the cleaning element 402 is positioned in a front portion of the robot 100. In this way, the robot (e.g., robot 100) moves forward and thereby cleans a center or middle portion of the environment 800. FIG. 11 also shows example backward movements 1106b1, 1106b2, and 1106b13, which occurred before or after forward movements 1106f1, 1106f2, and 1106f13. That is, backward movements 1106b1-1106b13 illustrate instances at which the robot (e.g., robot 100) was moving backwards relative to its cleaning element (e.g., cleaning element 402) for example to implement a turning or maneuver to begin a transition from one forward movement to another (e.g., forward movement 1006f1 to 1006f2).

FIG. 11 further exemplifies a navigation or movement of a robot (e.g., robot 100) involving an edge-follow or otherwise wall-follow algorithm. This is illustrated, for example, by forward movement 1110f and backward movement 1110b. As shown for FIG. 11, robot 100 follows an edge 1110c edge (e.g., a baseboard or otherwise wall or obstacle) of the environment (e.g., environment 800). Robot 100 moves in a forward direction (e.g., forward movement 1110f) relative to its cleaning element (e.g., cleaning element 402) thereby cleaning near or along 1110c edge (e.g., a wall). When robot 100 approaches corner 1110c (e.g., a corner of the environment such as two adjoining walls), then robot 100 engages or implements backward movement 1110b to rotate or otherwise alter its direction to continue moving in a forward direction (x-position direction) relative to the wall. In this way, robot 100 can clean a perimeter of the environment along one or more edges to ensure cleaning, disinfecting, or otherwise improvement occurs not only with respect to the center of the environment (e.g., forward movements 1106f1-1106f13), but also with respect to the edges of the environment (e.g., environment 800).

To accomplish the forward and/or backward movements (e.g., forward movements 1106f1-1106f12 and 1100f, backward movements 1106b1-1106b13 and 1110b) as illustrated for FIG. 11, processor 112 of robot 100 executes computing instructions, stored in memory 114. The computing instructions, when executed, cause processor 112 to actuate a motor (e.g., motor 254m1 and/or motor 254m2) to drive the robot 100 in a forward direction (e.g., forward movements 1106f1-1106f12 and 1100f) relative to the cleaning element (e.g., cleaning element 402). Further, the computing instructions, when executed, cause processor 112 to receive sensor data from a sensor (e.g., multi-directional sensor 108s1 and/or multi-directional sensor 108s2). The sensor data may indicate an object in the environment (e.g., environment 800) relative to the robot 100, for example, when the robot 100 strikes or other interacts with an obstacle 804, such as furniture or a wall within the environment. Still further, the computing instructions, when executed, cause processor 112 to actuate the motor (e.g., motor 254m1 and/or motor 254m2) based on the sensor data to cause the robot (e.g., robot 100) to alter its course while maintaining the forward direction relative to the cleaning element (e.g., cleaning element 402). Thus, the robot 100 can experience an increased amount of forward movement compared to backward movement (e.g., backward movements 1106b1-1106b13 and 1110b).

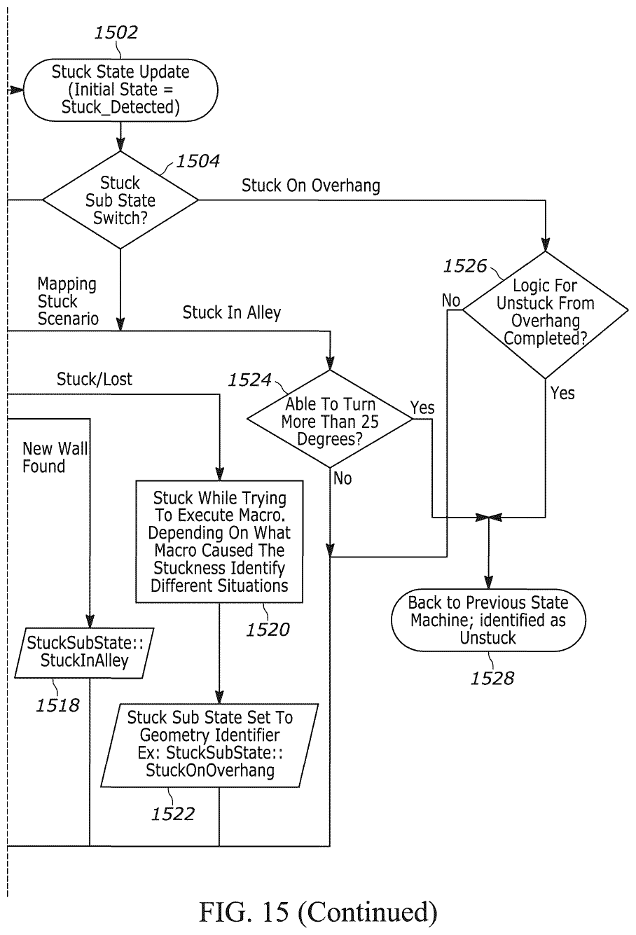

In this way, the cleaning element 402 can hold or otherwise collect debris as the robot 100 moves. In particular, in such aspects, robot 100 moving the cleaning element 402 is configured to hold or collect debris 1406 (e.g., as illustrated for FIG. 14) as the robot 100 moves in the forward direction (e.g., forward movements 1106f1-1106f12 and 1100f). By contrast, robot 100 may experience debris loss or falloff when it moves in a backward direction (e.g., backward movements 1106b1-1106b13 and 1110b). Thus, an algorithm implemented by processor 112 seeks to maximize debris 1706 retention and collection by maximizing a total forward amount that robot 100 experiences for any given cleaning session. For example, at least in some aspects, robot 100, when moving the cleaning element 402 in a given environment (e.g., environment 800) is configured to hold or collect at least 90 percent of a total amount of debris 1406 acquired or otherwise experienced by the cleaning element (e.g., cleaning element 402) as the robot moves in the forward direction. The given total amount of debris can be an amount of debris that is acquired or otherwise experienced by the robot during a cleaning session of the robot. A cleaning session may comprise, by way of non-limiting example, a duty cycle of the robot, a time to clean a given environment (e.g., a room), and/or a given period of time of cleaning (e.g., 10 minutes, 15 minutes, or some other unit time of cleaning).

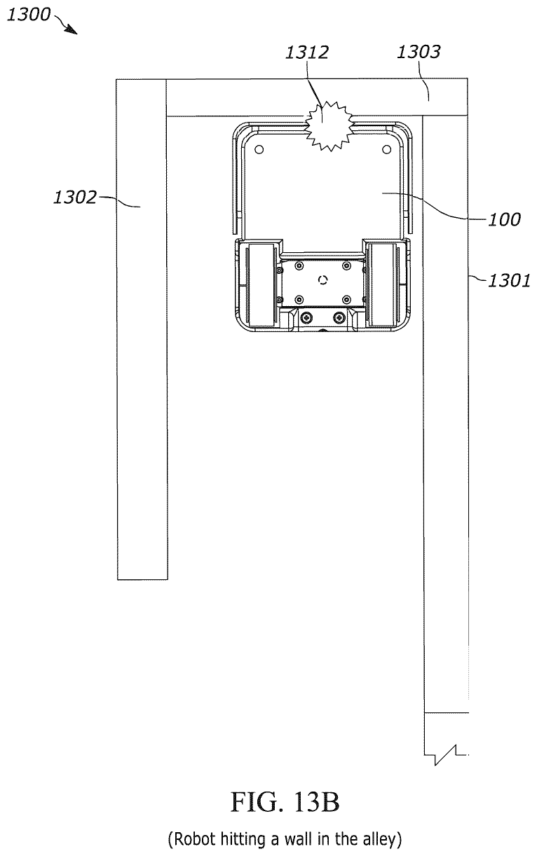

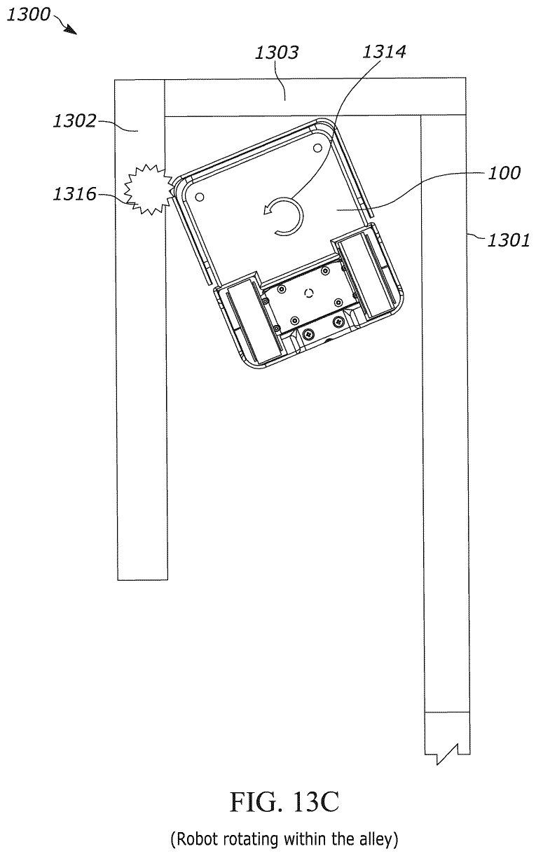

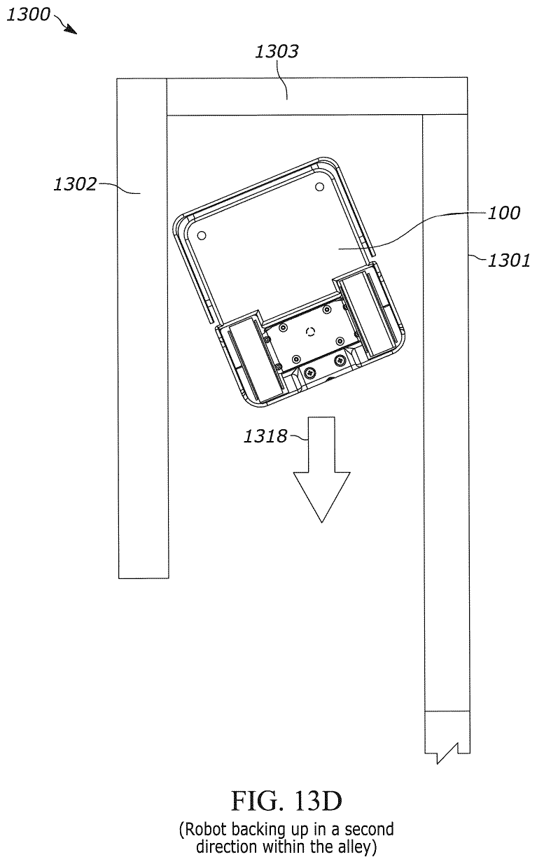

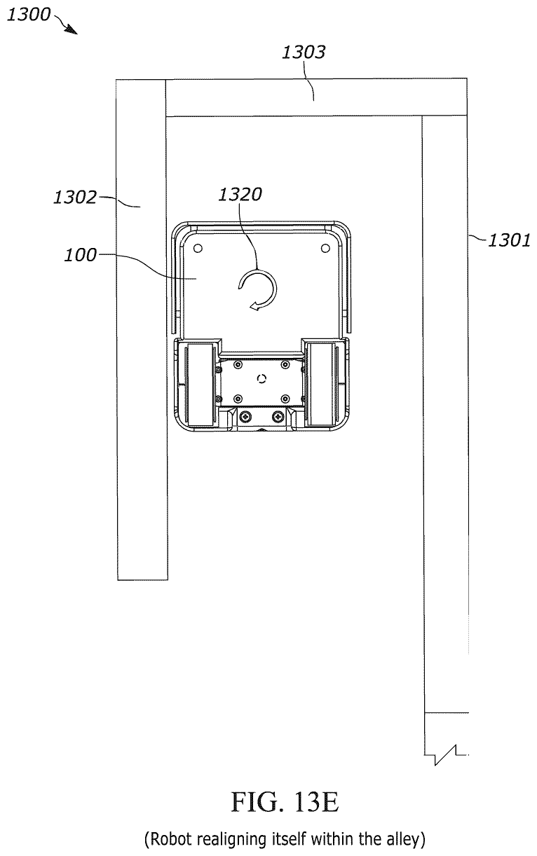

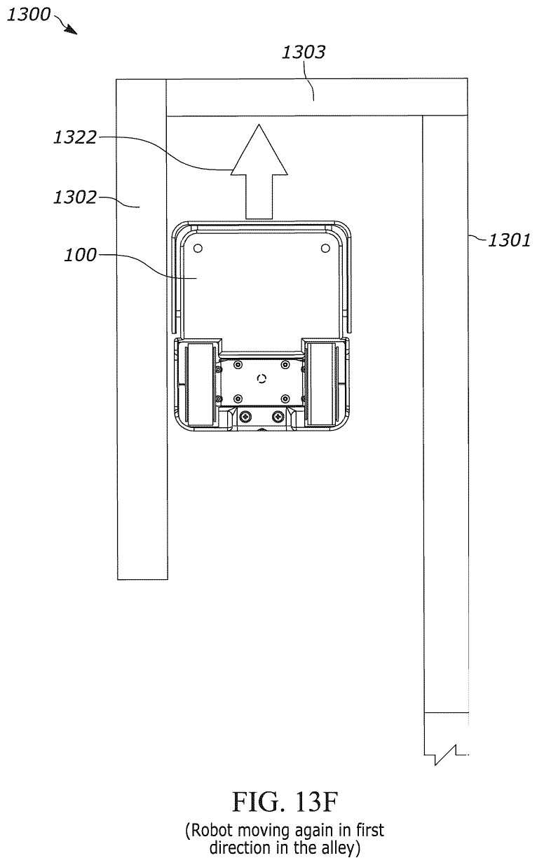

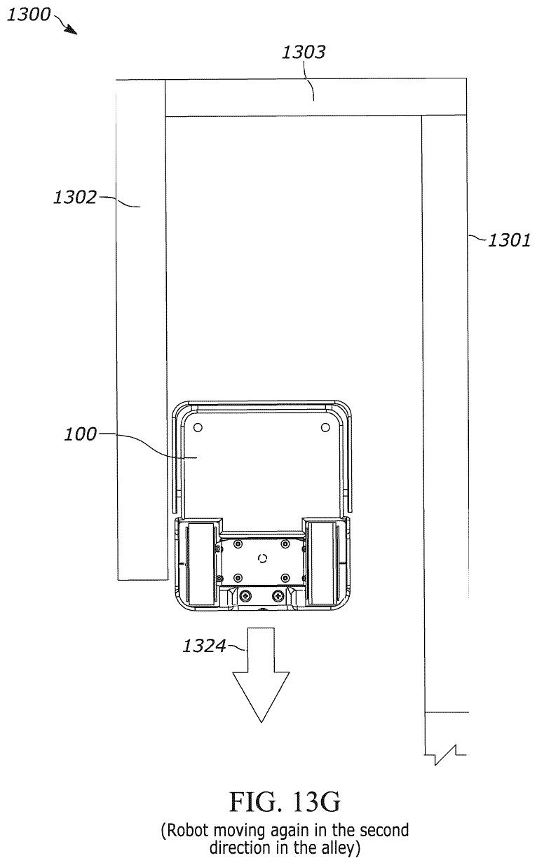

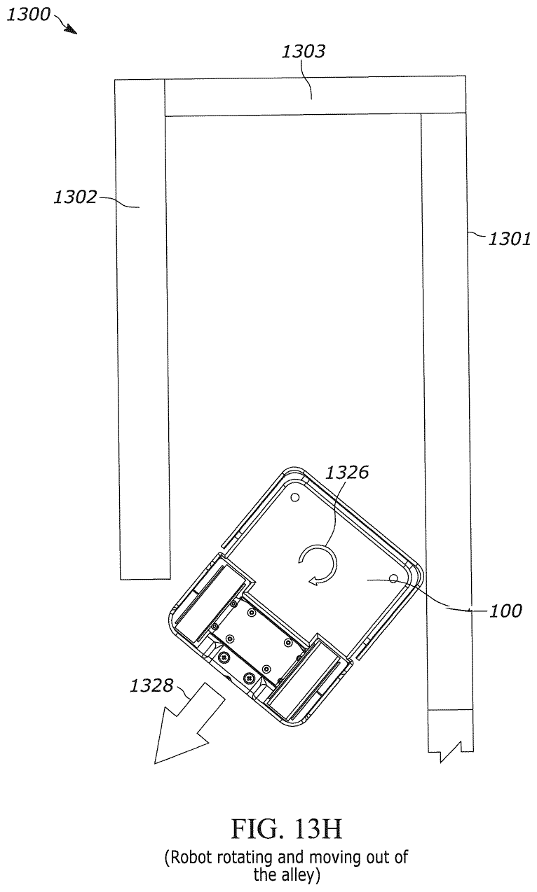

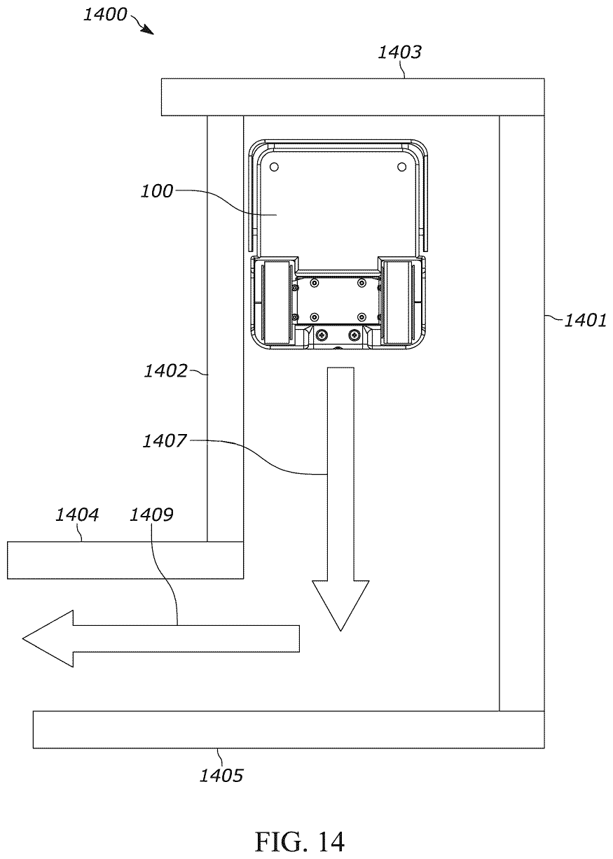

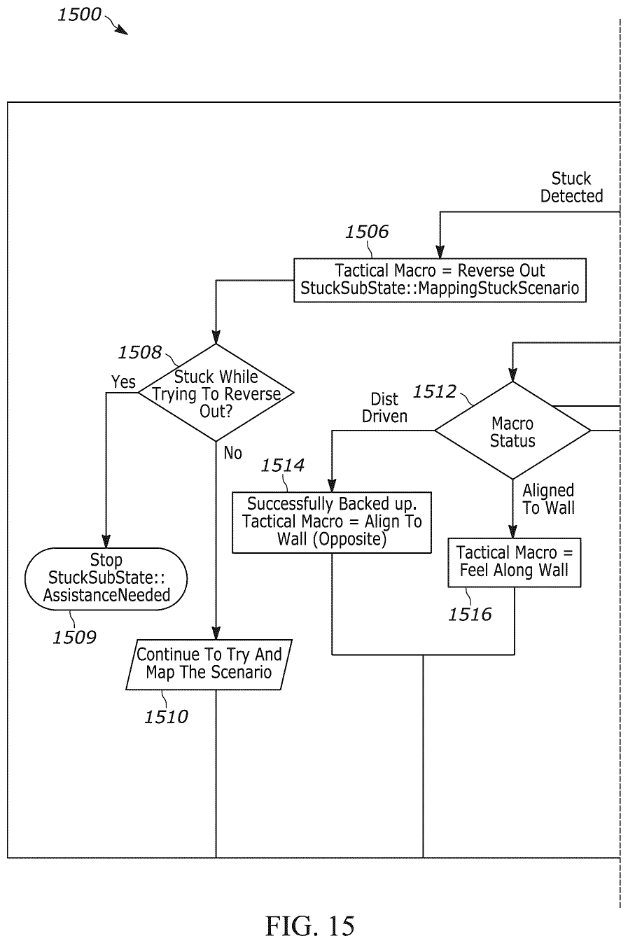

FIG. 12 illustrates a flowchart for a navigation algorithm 1200 for a robot (e.g., robot 100) maneuvering within a confined area (e.g., such as a hallway or alley cleaning area or space) in accordance with various aspects disclosed herein. Navigation algorithm 1200 of FIG. 12 is further described and depicted by FIGS. 13A-13G which illustrate example navigations or movements of a robot (e.g., robot 100), respectively, within a confined area in accordance with various aspects disclosed herein.

Navigation algorithm 1200 refers to a robot (e.g., robot 100), which may comprise, as described herein, a body (e.g., body 102) comprising a chassis (e.g., 102c) and an outer perimeter (e.g., outer perimeter 102op). The body of the robot may further comprise a front portion, an opposing back portion, and a body length disposed between the front portion and the opposing back portion. The front portion may comprise a first side, an opposing second side, and a front portion width disposed between the first side and the second side (e.g., left-to-right dimension). In addition, the body may further comprise a cleaning element (e.g., cleaning element 402) positioned relative to the front portion. The robot may further comprise a motor (e.g., motor 254m1 and/or motor 254m2) configured to move the robot within an environment (e.g., environment). The robot may further comprise at least one sensor (e.g., multi-directional sensor 108s1 and/or multi-directional sensor 108s2). In various aspects, the sensor may comprise a joystick sensor, a Hall-effect sensor, an IMU, a sensor for detecting motor current, or any other sensor as described herein. The robot may further comprise a processor (e.g., processor 112) communicatively coupled to the at least one sensor. A computer memory (e.g., computer memory 114) may be communicatively coupled to the processor. The computer memory can store computing instructions that, when executed by the processor, cause the processor to implement navigation algorithm 1200. It is to be understood that navigation algorithm 1200 is an example non-limiting algorithm that may form a portion of, or otherwise be stored or implemented as part of, the computing instructions stored on memory 114 and executable by processor 112. Additional or alternative algorithms may also be stored and executed by memory 114 and processor 112, respectively, including those as described herein.

With further reference to FIG. 12, block 1202 of navigation algorithm 1200 comprises actuating the motor to drive the robot in a first direction. In the example of FIG. 12, the robot moves in a confined area (e.g., an alley) within the environment. The confined area may be an alley, nook, or otherwise narrow or confined area of an environment. For example, FIG. 13A illustrates example navigation or movement of a robot within a confined area in accordance with various aspects disclosed herein. As shown for FIG. 13A, environment 1300 comprises a confined area (e.g., an alley) having a first boundary 1301 (e.g., a first edge or wall), a second boundary 1302 (e.g., a second edge or wall), and a third boundary 1303 (e.g., a third edge or wall). Third boundary 1303 is perpendicular or generally perpendicular to the first boundary 1301 and/or second boundary 1302. A width of the confined area may extend between the first boundary 1301 and the second boundary 1302. Such confined area width may comprise or be sized greater than the front portion width of the robot allowing the robot to travel in the confined area (e.g. alley).

However, in various aspects, a width of the confined area (e.g., the alley) may be less than the body length of the robot, which would cause the robot to be unable to rotate fully (e.g., more than 90 degrees and/or 360 degrees within the alley). A confined area (e.g., an alley) may define multiple areas (e.g., 1^{st}, 2^{nd}, 3^{rd}, 4^{th}, and 5^{th}) defined by the first boundary 1301 (e.g., first wall), the second boundary 1302 (e.g., second wall), and/or other boundaries. Such areas may comprise side areas of the alley and/or floor areas (e.g., floor areas such as corner areas formed between or by any of first boundary 1301, second boundary 1302, and/or third boundary 1303) to be cleaned by a cleaning element of the robot.

As shown for FIG. 13A, robot 100 moves in first direction 1310 towards third boundary 1303 and along or relatively near first boundary 1301 (e.g., a first edge or wall). FIG. 13B illustrates further example navigation or movement of a robot within the confined area of FIG. 13A in accordance with various aspects disclosed herein. As shown for FIG. 13B, robot 100 hits or strikes 1303 a wall (e.g., third boundary 1303) of the confined area (e.g., alley).

With reference to FIG. 12, block 1204 of navigation algorithm 1200 comprises actuating the motor to rotate the robot relative to first direction 1310. For example, the computing instructions may implement a routine that attempts to turn a side of the robot (e.g., robot 100) along third boundary 1303 so as to drive along third boundary 1303 to clean an edge (e.g., wall) associated with third boundary 1303. However, the limited space of the confined area prevents robot 100 from rotating within the confined area. For example, FIG. 13C illustrates further example navigation or movement of a robot within the confined area of FIGS. 13A-13B in accordance with various aspects disclosed herein. As shown for FIG. 13C, robot 100 rotates 1314 within environment 1300 but hits or strikes 1316 second boundary 1302 (e.g., a second wall) of the confined area.

With reference to FIG. 12, block 1206 of navigation algorithm 1200 comprises detecting, by the at least one sensor, that robot 100 is in a stuck state within the confined area. Detecting that robot 100 is in a stuck state may comprise, for example, detecting that the first boundary 1301 or the second boundary 1302 prevents the robot from rotating less than or equal to 90 degrees relative to the first direction. Additionally, or alternatively, detecting that robot 100 is in a stuck state may comprise detecting that the first boundary or the second boundary prevents the robot from rotating less than or equal to 60 degrees relative to the first direction. Additionally, or alternatively, detecting that robot 100 is in a stuck state may comprise detecting that the first boundary or the second boundary prevents the robot from rotating less than or equal to 45 degrees relative to the first direction. It is to be understood, however, that additional and/or different values of degrees may be used to determine whether robot 100 may rotate sufficiently within the confined area. It is worth nothing that robots with a generally round shape have no need for such navigation protocols as rotation is guaranteed if the robot fits in the space. However, such round robots also cannot provide the level of cleaning in the corners that the robots of the present disclosure can.

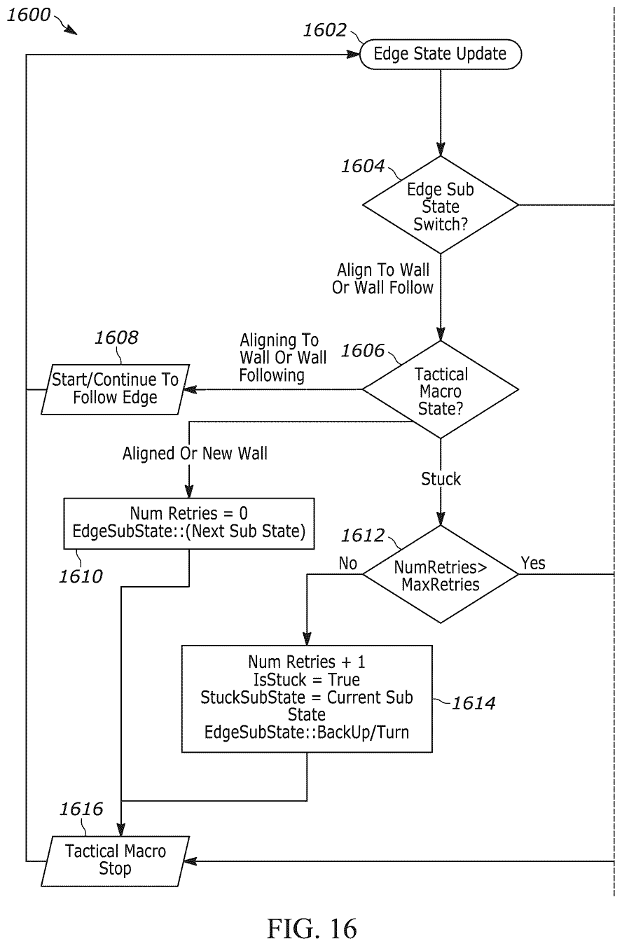

With reference to FIG. 12, block 1208 of navigation algorithm 1200 comprises attempting to exit the stuck state by further maneuvering (e.g., rotating and/or driving) the robot in the confined area. This may include maneuvering robot 100 as describe herein for FIGS. 15 and/or 16, or elsewhere herein. Once it is determined that the stuck state cannot be exited, the computing instructions will determine that robot 100 is within a confined space (e.g., an alley).

With reference to FIG. 12, block 1210 of navigation algorithm 1200 comprises cleaning a second side (e.g., near the second boundary 1302) of an alley. In particular, block 1210 of navigation algorithm 1200 may comprise actuating the motor of robot 100 to maneuver at least a portion of the first side against the first boundary or at least a portion of the second side against the second boundary, e.g., as shown for example by robot 100 of FIG. 13C where at least a portion of the second side of robot 100 is maneuvered against second boundary 1302.

Additionally, or alternatively, cleaning a second side (e.g., near the second boundary) of an alley may further comprise actuating the motor of the robot to maneuver in a second direction. The second direction may be an opposite (e.g., a reverse) direction relative to the first direction. For example, FIG. 13D illustrates further example navigation or movement of a robot within the confined area of FIGS. 13A-13C in accordance with various aspects disclosed herein. As shown for FIG. 13D, robot 100 is maneuvered in second direction 1318 while the second portion of the second side of robot 100 remains connected to the wall allowing a cleaning element (e.g., cleaning element 402) to move over the area proximate to second boundary 1302 thereby cleaning that area. In this way, robot 100 is able to clean the alley by moving forward and reverse within the alley to clean various areas and surfaces of the alley with its cleaning element. That is, at least in some examples, robot 100 is configured to drive along first boundary 1301 in first direction 1310 (as shown for 13A), and further drive along the second boundary 1302 in the second direction 1318 to clean the alley on both sides.

Additionally, or alternatively, cleaning a second side (e.g., near the second boundary 1302) of an alley may further comprise maneuvering robot 100 again in first direction 1310 to further along the second boundary 1302. This may allow the robot to fit within, and therefore clean with its cleaning element, the corner area formed by second boundary 1302 and third boundary 1303. More generally, the computing instruction stored on the computer memory may be configured, when executed by the processor, to cause the processor to further actuate the motor of the robot remaneuver the robot in the first direction such that the robot drives along the first boundary 1301 or second boundary 1302 until the at least one sensor detects a third boundary 1303 which is disposed at an angle with respect to the first boundary or the second boundary. This moves the robot in the first direction again to clean a corner where two walls meet.

For example, FIGS. 13E and 13F illustrate further example navigations or movements of robot 100 within the confined area of FIGS. 13A-13D in accordance with various aspects disclosed herein. For example, as shown for FIG. 13E, the computing instruction stored on the computer memory may be configured, when executed by the processor, to cause the processor to actuate the motor to rotate 1320 a side of robot 100 against second boundary 1302. As shown for FIG. 13F, the computing instruction stored on the computer memory may be configured, when executed by the processor, to cause the processor to actuate the motor of robot 100 to remaneuver the robot in the first direction 1322. As shown robot can be driven along the first boundary 1301 or second boundary 1302 to cover (e.g., to clean) with the cleaning element (e.g., the cleaning pad) at least one portion of the confined area (e.g., a corner of the confined area defined by second boundary 1302 and third boundary 1303) not previously covered (e.g., cleaned) by the cleaning element when the robot was prevented from rotating by less than or equal to 90 degrees.

With reference to FIG. 12, block 1212 of navigation algorithm 1200 comprises maneuvering robot 100 in the second direction and reaching an end of the alley on a side (e.g., a second side). For example, FIG. 13G illustrates further example navigation or movement of a robot within the confined area of FIGS. 13A-13F in accordance with various aspects disclosed herein. For example, as shown for FIG. 13G, robot is configured to drive in the second direction 1324. A longitudinal axis of robot 100 is disposed at an angle with respect to a longitudinal axis of the confined area. As shown for FIG. 13G, robot 100 is configured to reach an end of the confined area (e.g., alley).

With reference to FIG. 12, block 1214 of navigation algorithm 1200 comprises maneuvering robot 100 to reverse out of the confined area (e.g., alley). This is shown, by way of non-limiting example, for FIG. 13H, which illustrates further example navigation or movement of a robot within the confined area of FIGS. 13A-13G in accordance with various aspects disclosed herein. For example, with reference to FIG. 12, block 1216 of navigation algorithm 1200 comprises rotating 1326 or otherwise turning robot 100 to detect bumps, such as the robot hitting a wall or otherwise edge. This may comprise, by way of non-limiting example, when the robot drives in the second direction 1324, the robot drives a first distance and then rotates with respect to the second direction 1324 to determine whether the robot is free of the first boundary and/or second boundary (e.g., free of the confined area). In some aspects, if the robot detects, via the at least one sensor, the first boundary or the second boundary, which prevents the robot from rotating less than or equal to 90 degrees relative to the second direction, the robot can continue to drive in the second direction by a second distance. Still further, if the robot detects, via the at least one sensor, the first boundary or the second boundary, which prevents the robot from rotating less than or equal to 90 degrees relative to the second direction, the robot continues to drive in the second direction by a third distance. In this way, the robot can continue to travel along the first or second boundary in the second direction until the robot detects no boundaries, which indicates to processor 112 that the robot is free of the confined area (e.g., alley).

If there are no bumps (e.g., impact with a wall or boundary), robot 100 can be reversed (block 1218) in a third direction 1328 to exit the confined area (e.g., alley).

Once robot 100 exits the confined area (e.g., the alley) the stuck state may be updated (e.g., to “not stuck” or otherwise a “false” value), and, at block 1220 navigation algorithm 1200 comprises returning operation of robot 100 to a cleaning edge/fill state as described herein, for example, for FIG. 11 or elsewhere herein

FIG. 14 illustrates example navigation or movement of a robot (e.g., robot 100) within a further example environment 1400 in accordance with various aspects disclosed herein. In the example of FIG. 14, example environment 1400 comprises a first boundary 1401, a second boundary 1402, a third boundary 1403, a fourth boundary 1404, and fifth boundary 1405. As shown in the example of FIG. 14, the computing instructions as stored in memory (e.g., memory 114) are configured, when executed by the processor, to cause the processor to detect by the at least one sensor, a further boundary (e.g., fifth boundary 1405 which may comprise an edge or wall) as the robot travels in the second direction 1407 (e.g., backing up towards boundary 1405).

The computing instructions as stored in memory (e.g., memory 114) may further be configured, when executed by the processor, to cause the processor to actuate the motor maneuver the robot in a third direction 1409. The third direction may comprise a direction at an angle (e.g., a 90 degree angle) to the second direction 1407. Travel in the third direction moves the robot away from a space (e.g., an alley) of the confined area (e.g., the alley defined by walls of the first boundary 1401, a second boundary 1402, a third boundary 1403) into a second confined area (e.g. a second alley) of example environment 1400 having a boundary (e.g., fourth boundary 1405) and a yet a still further boundary (e.g., fifth boundary 1405). Fourth boundary 1404 and fifth boundary 1405 may comprise walls or other boundaries within environment 1400, such as toilet or furniture boundary or the like.

FIG. 15 illustrates a flowchart for a stuck state algorithm 1500 for a robot maneuvering within in an environment in accordance with various aspects disclosed herein. It is to be understood that stuck state algorithm 1500 is an example non-limiting algorithm that may form a portion of the computing instructions stored on memory 114 and executable by processor 112. Additional or alternative algorithms may also be stored and executed by memory 114 and processor 112, respectively, including those as described herein. At block 1502, stuck state algorithm 1500 comprises detecting a stuck state. This may include detecting, by the at least one sensor, that the robot (e.g., robot 100) is in a stuck state within a confined area as described and/or illustrated herein for FIGS. 12, 13D, and 13C, or elsewhere herein.

At block 1504, stuck state algorithm 1500 comprises switching between operations depending on a stuck state type. In the example of FIG. 15, various stuck state types are illustrated, e.g., an edge-stuck state type, mapping stuck state, an alley stuck state, and an overhang stuck state type. However, it should be understood that additional and/or alternative stuck state types may be implemented. Any one or more stuck states may be a value or flag stored in memory (e.g., memory 114).

At block 1506, stuck state algorithm 1500 comprises detecting an edge-stuck state type. The edge-stuck state type may be assigned (e.g., by processor 112) when processor 112 determines, based on sensor feedback, that robot 100 is stuck on a wall or otherwise edge as determined, for example, by one or more sensors of robot 100. Upon detection of the edge-stuck state type, a macro function (e.g., a portion of computing instructions) of stuck state algorithm 1500 may be executed to attempt to reverse robot 100 out of its current stuck state.

At block 1508, stuck state algorithm 1500 comprises determining, by processor 112 based on sensor data collected by one or more sensors of the robot, whether robot 100 remains in the edge-stuck state type. Such determination may be determined by reversing and/or rotating robot 100 to collect sensor data from interaction (e.g., hitting a wall or boundary as illustrated by FIGS. 13D and 13C) between robot 100 and its environment.

At block 1509, stuck state algorithm 1500 comprises determining, by processor 112, that the robot has exhausted options (e.g., no additional computing instructions or macros) allowing robot 100 to free itself from the stuck state. In such instances, robot 100 may output an indication that is stuck. Such indication may comprise output including a light (e.g., an LED), for example a flashing or strobing light, or output comprising an audible sound (e.g., a beeping sound), to alert a user that robot 100 is in a stuck state and needs assistance becoming unstuck. A user may then manually reposition the robot in a different location such that the robot may continue maneuvering in the environment, for example, implementing an unstuck navigation algorithm.

At block 1510, stuck state algorithm 1500 comprises determining, by processor 112 based on sensor data collected by one or more sensors of the robot, that robot 100 is free of its edge-stuck state after reversing in its environment. In such aspects, processor 112 may update the stuck state (block 1502) to indicate that the robot is no longer stuck.

At block 1512, stuck state algorithm 1500 comprises detecting a mapping stuck state type. The mapping stuck state type may be assigned (e.g., by processor 112) when processor 112 determines, based on sensor feedback, that robot 100 needs additional information or data (e.g., sensor data) for exiting a stuck state as determined, for example, by one or more sensors of robot 100. Upon detection of the mapping stuck state, a macro function (e.g., a portion of computing instructions) of stuck state algorithm 1500 can be executed to attempt to maneuver robot 100 to move robot 100 to trigger one or more sensors of robot 100 to gather the additional information or data (e.g., sensor data).

At block 1514, stuck state algorithm 1500 comprises driving robot 100 a given distance (e.g., a foot or less) to gather additional information or data (e.g., sensor data). Additionally, or alternatively, a macro function (e.g., a portion of computing instructions) may be implemented to align robot 100 to a wall or edge, such as an opposite wall or edge (e.g., as shown for example by FIG. 13E). If robot 100 can drive the given distance and/or align itself to a wall or edge, then processor 112 may update the stuck state (block 1502) to indicate that the robot is no longer stuck.

At block 1516, stuck state algorithm 1500 comprises aligning robot 100 to a wall or an edge, and then implementing a macro function (e.g., a portion of computing instructions) to feel (e.g., via sensors) or otherwise drive robot 100 along the wall or edge (e.g., as shown for example by FIGS. 13E and 13F). If robot 100 can align itself to a wall or otherwise edge and/or to feel or otherwise drive robot 100 along the wall or edge, then processor 112 may update the stuck state (block 1502) to indicate that the robot is no longer stuck.

At block 1518, stuck state algorithm 1500 comprises determining, by processor 112 based on sensor data collected by one or more sensors of the robot, that robot 100 has struck or found a new or additional wall (e.g., a second boundary as described herein for FIGS. 13B and/or 13C). Processor 112 may then implement a macro function (e.g., a portion of computing instructions) regarding alley navigation as described herein for FIG. 12 and/or FIGS. 13A-13H. Processor 112 may also update a stuck state type of robot 100 (block 1502) to an alley stuck state type, and perform additional and/or alternative instructions as described, by way of non-limiting example, for blocks 1524 and/or 1528, as shown and describe for FIG. 15.

At block 1520, stuck state algorithm 1500 comprises determining a given stuck state based on a given macro executed and/or information or data (e.g., sensor data) collected when performing the given macro. Based on the given macro executed and/or information or data (e.g., sensor data) collected when performing the given macro processor 112 can identify different patterns or otherwise situations causing a stuck state. Such identification can be determined by analyzing the given macro executed and/or information or data (e.g., sensor data) collected when performing the given macro as described for block 1522.

At block 1522, stuck state algorithm 1500 comprises determining by processor 112, via implementation of a macro function (e.g., a portion of computing instructions), certain geometry data, distance data, or other data determinable from the sensor(s) of robot 100, a given stuck state of robot 100. This may include, by way of non-limiting example, determining that robot 100 is in an overhang stuck state type, as further described herein for block 1526. In any event, processor 112 may also update its stuck state type (block 1502), and perform additional and/or alternative instructions as described herein for FIG. 15.

At block 1524, stuck state algorithm 1500 comprises detecting an alley stuck state type. The alley stuck state type may be assigned (e.g., by processor 112) when processor 112 determines, based on sensor feedback, that robot 100 is stuck because a boundary (e.g., a wall) prevents the robot from rotating less than or equal to 25 degrees or some over value (e.g., 90 degrees) relative to a given direction as determined, for example, by one or more sensors of robot 100. Upon detection of the alley stuck state type, a macro function (e.g., a portion of computing instructions) of stuck state algorithm 1500 can be executed to attempt to maneuver robot 100 to move robot 100 out of its current stuck state (e.g., as described herein for FIGS. 13A-13H). If robot 100 can rotate freely or otherwise greater than a specified number of degrees (e.g., a predefined degree value such as 90 degrees), then processor 112 may update a stuck state value (blocks 1502 and/or 1528) to indicate that the robot is no longer stuck.

At block 1526, stuck state algorithm 1500 comprises detecting an overhang stuck state type. The overhang stuck state type may be assigned (e.g., by processor 112) when processor 112 determines, based on sensor feedback, that robot 100 is stuck because at least a portion of robot 100 overhangs a ledge or is otherwise titled upwards or downwards from a planar or flat surface (e.g., a floor of an environment) as determined, for example, by one or more sensors of robot 100. Upon detection of the alley overhang stuck state type, a macro function (e.g., a portion of computing instructions) of stuck state algorithm 1500 can be executed to attempt to maneuver robot 100 to move robot 100 out of its current stuck state. If robot 100 is able reposition its body relative to (e.g., parallel to or along) a planar or flat surface (e.g., a floor of an environment) as determined by one or more sensors of robot 100, then processor 112 may update the stuck state (blocks 1502 and/or 1528) to indicate that the robot is no longer stuck.

At block 1528, stuck state algorithm 1500 comprises returning robot 100 to a normal operating state. In such aspects, processor 112 may update the stuck state (block 1502) to indicate that the robot is no longer stuck. In such aspects, the robot may continue maneuvering in the environment, for example, implementing an unstuck navigation algorithm (e.g., an edge/fill algorithm as described for FIG. 11).

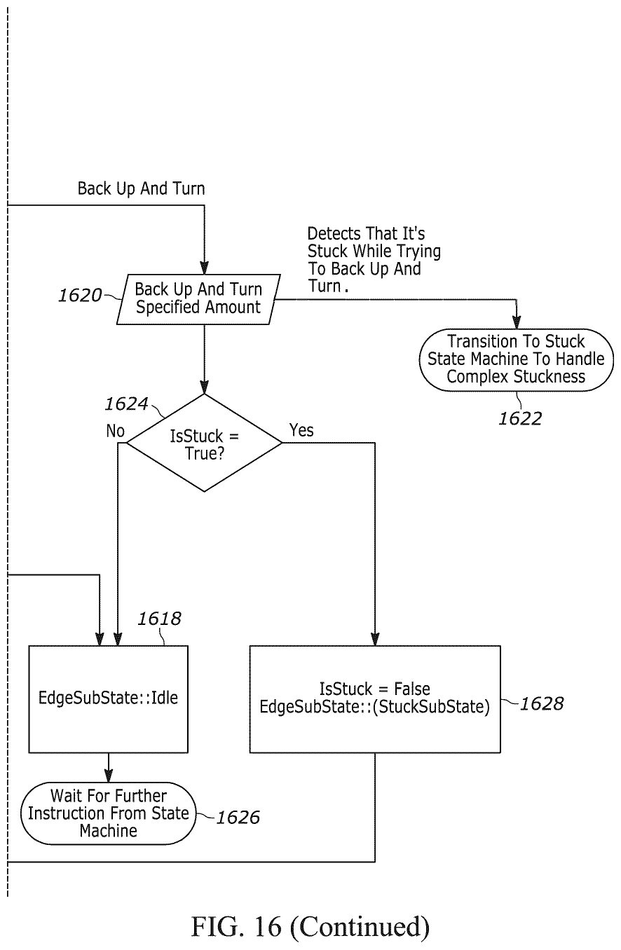

FIG. 16 illustrates a flowchart for an edge-state-to-stuck-state transition algorithm 1600 for a robot maneuvering within in an environment in accordance with various aspects disclosed herein. It is to be understood that edge-state-to-stuck-state transition algorithm 1600 is an example non-limiting algorithm that may form a portion of the computing instructions stored on memory 114 and executable by processor 112. Additional or alternative algorithms may also be stored and executed by memory 114 and processor 112, respectively, including those as described herein. At block 1602, edge-state-to-stuck-state transition algorithm 1600 comprises updating an edge state. The edge state may comprise or define a status of robot 100 as aligned or positioned against or with respect to an edge, e.g., a wall or boundary, or otherwise as described herein. The edge-state-to-stuck-state transition algorithm 1600 may be implemented when transition to and from unstuck and stuck states of robot 100. In one aspect, edge-state-to-stuck-state transition algorithm 1600 may be implemented for or as part of navigation algorithm 1200 as shown and described herein for FIGS. 12 and/or 13A-13G regarding navigating and/or maneuvering robot 100 within a confined area, e.g., such as an alley shaped environment.

At block 1604, edge-state-to-stuck-state transition algorithm 1600 comprises switching between operations depending on a position or current state of robot 100. In the example of FIG.

16, various positions or current states are illustrated, e.g., an align to wall state or position, a wall follow state or position, a back up state or position, and/or a turning state or position. However, it should be understood that additional and/or alternative positions or current states may be implemented.

At block 1606, edge-state-to-stuck-state transition algorithm 1600 comprises determining, by processor 112 based on sensor data collected by one or more sensors, that robot 100 is in an align to wall position or current state and/or wall follow position or current state. A macro function (e.g., a portion of computing instructions) of edge-state-to-stuck-state transition algorithm 1600 can be executed to maneuver robot 100 based on the align to wall position or current state and/or wall follow position or current state, e.g., as described for blocks 1608, 1610, and 1612.

At block 1608, edge-state-to-stuck-state transition algorithm 1600 comprises determining, by processor 112 based on sensor data collected by one or more sensors, that robot 100 has an align to wall position or current state and/or a wall follow position or current state. In such implementation, the current edge state may be updated (block 1602) to reflect the current state of robot 100 in the environment, which may comprise the robot being aligned with and/or following alongside wall or other edge.

At block 1610, edge-state-to-stuck-state transition algorithm 1600 comprises determining, by processor 112 based on sensor data collected by one or more sensors, that the robot has a new align to wall position or current state and/or a new wall follow position or current state. Such state(s) may identify or otherwise define when robot 100 has moved from a first wall to a second wall. A macro function (e.g., a portion of computing instructions) of edge-state-to-stuck-state transition algorithm 1600 can be executed to maneuver robot 100 based on the new align to wall position or current state and/or a new wall follow position or current state. This may include trying (and/or retrying) maneuver robot 100 against the new wall and/or driving the robot forward after aligning against the new wall. In some aspects, at block 1616, the implemented macro may stop, e.g., after a certain number of tries, where the current edge state may be updated (block 1602) to reflect the current state of robot 100 in the environment. Such update may indicate whether the robot is in a stuck state or unstuck state.

At block 1612, edge-state-to-stuck-state transition algorithm 1600 comprises determining, by processor 112 based on sensor data collected by one or more sensors, whether robot 100 has exceeded a predefined number of max retries to exit a stuck state.

At block 1614, edge-state-to-stuck-state transition algorithm 1600 comprises determining, by processor 112 based on sensor data collected by one or more sensors, that the robot 100 has not exceeded a predefined number of max retries. A macro function (e.g., a portion of computing instructions) of edge-state-to-stuck-state transition algorithm 1600 can be executed to maneuver robot 100 to rotate, turn, and/or backup (e.g., as described for FIGS. 13B and 13C) in an attempt to transition robot 100 from the unstuck state. In some aspects, at block 1616, the implemented macro may stop, e.g., after a certain number of tries, where the current edge state may be updated (block 1602) to reflect the current state of robot 100 in the environment. Such update may indicate that whether the robot is in a stuck state or an unstuck state.

At block 1618, edge-state-to-stuck-state transition algorithm 1600 comprises determining, by processor 112 based on sensor data collected by one or more sensors, that the robot 100 has exceeded a predefined number of max retries. A macro function (e.g., a portion of computing instructions) of edge-state-to-stuck-state transition algorithm 1600 can be executed to have robot 100 enter an idle state. The idle state can define a state of the robot until the robot implements or otherwise waits to implement further instructions (block 1626) based on the current state machine, e.g., stored in memory 114, of robot 100 and defining robot 100 current operation.

At block 1620, edge-state-to-stuck-state transition algorithm 1600 comprises determining, by processor 112 based on sensor data collected by one or more sensors, that robot 100 has a backup position or current state and/or turning position or current state. A macro function (e.g., a portion of computing instructions) of edge-state-to-stuck-state transition algorithm 1600 can be executed to have robot 100 attempt to back up and/or turn a specified amount. For example, an amount to back up may comprise a foot or less. Still further, an amount to turn may comprise 25 degrees. It is to be understood, however, that additional and/or alternative amounts and/or degrees may be used.

At block 1622, edge-state-to-stuck-state transition algorithm 1600 comprises determining, by processor 112 based on sensor data collected by one or more sensors, that the robot 100 is in a stuck state even after attempting to back up (reverse) or turn robot 100 in the environment. Such determination may cause state-to-stuck-state transition algorithm 1600 to call or otherwise invoke stuck state algorithm 1500, as described herein for FIG. 15, to attempt to maneuver or otherwise navigate robot 100 out of the stuck state.

At block 1624, edge-state-to-stuck-state transition algorithm 1600 comprises determining, by processor 112 based on sensor data collected by one or more sensors, that the robot 100 is in a stuck state. In one implementation, a macro function (e.g., a portion of computing instructions) of edge-state-to-stuck-state transition algorithm 1600 can be executed to have robot 100 enter an idle state (block 1618). The idle state can define a state of the robot until the robot implements or otherwise waits to implement further instructions (block 1626) based on the current state machine, e.g., stored in memory 114, of robot 100 and defining robot 100's current operation.

At block 1628, edge-state-to-stuck-state transition algorithm 1600 comprises determining, by processor 112 based on sensor data collected by one or more sensors, that the robot 100 is not in a stuck state. In such aspect, a macro may be implemented to stop (block 1616) backup/turning routines and where the current edge state may be updated (block 1602) to reflect the current state of robot 100 in the environment. Such update may indicate that whether the robot is in a stuck state or unstuck state.

### Additional Considerations

Although the disclosure herein sets forth a detailed description of numerous different aspects, it should be understood that the legal scope of the description is defined by the words of the aspects set forth at the end of this patent and equivalents. The detailed description is to be construed as exemplary only and does not describe every possible aspect since describing every possible aspect would be impractical. Numerous alternative aspects may be implemented, using cither current technology or technology developed after the filing date of this patent, which would still fall within the scope of the claims.

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain aspects are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example aspects, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example aspects, comprise processor-implemented modules.

Similarly, the methods or routines described herein may be at least partially processor implemented. For example, at least some of the operations of a method may be performed by one or more processors or processor-implemented hardware modules. The performance of certain of the operations may be distributed among the one or more processors, not only residing within a single machine, but deployed across a number of machines. In some example aspects, the processor or processors may be located in a single location, while in other aspects the processors may be distributed across a number of locations.

The performance of certain of the operations may be distributed among the one or more processors, not only residing within a single machine, but deployed across a number of machines. In some example aspects, the one or more processors or processor-implemented modules may be located in a single geographic location (e.g., within a home environment, an office environment, or a server farm). In other aspects, the one or more processors or processor-implemented modules may be distributed across a number of geographic locations.

### ASPECTS OF THE DISCLOSURE

The following aspects are provided as examples in accordance with the disclosure herein and are not intended to limit the scope of the disclosure.
A. A robot configured for cleaning, the robot comprising:
a body comprising a chassis and an outer perimeter, and the body further comprising a front portion, an opposing back portion, and a body length disposed between the front portion and the opposing back portion,
wherein the body further comprises a cleaning element positioned relative to the front portion,
wherein the front portion comprises a first side, an opposing second side, and a front portion width disposed between the first side and the second side;
a motor configured to move the robot within an environment;
at least one sensor;
a processor communicatively coupled to the at least one sensor;
a computer memory communicatively coupled to the processor; and
computing instructions stored on the computer memory and configured, when executed by the processor, to cause the processor to:
actuate the motor to drive the robot in a first direction, wherein the robot moves in a confined area within the environment, the confined area having a first boundary and a second boundary, and a confined area width extending between the first boundary and the second boundary, wherein the confined area width is sized greater than the front portion width of the robot;
actuate the motor to rotate the robot relative to the first direction;
detect, by the at least one sensor, that the first boundary or the second boundary prevents the robot from rotating less than or equal to 90 degrees relative to the first direction;
actuate the motor to maneuver at least a portion of the first side against the first boundary or at least a portion of the second side against the second boundary; and
actuate the motor to maneuver in a second direction, the second direction being an opposite direction relative to the first direction.
B. The robot of paragraph A, wherein the computing instruction stored on the computer memory and configured, when executed by the processor, to cause the processor to further: actuate the motor to remaneuver the robot in the first direction, wherein the robot drives along the first boundary or second boundary until the at least one sensor detects a third boundary which is disposed at an angle with respect to the first boundary or the second boundary.
C. The robot of paragraph B, wherein the third boundary is generally perpendicular to the first and/or second boundary.
D. The robot of paragraphs A to C, wherein the computing instruction stored on the computer memory and configured, when executed by the processor, to cause the processor to further: actuate the motor to remaneuver the robot in the first direction, wherein the robot drives along the first boundary or second boundary to cover with the cleaning element at least one portion of the confined area not previously covered by the cleaning element when the robot was prevented from rotating by less than or equal to 90 degrees.
E. The robot of paragraphs A to D, wherein the robot drives along the first boundary in the first direction, and wherein the robot drives along the second boundary in the second direction.
F. The robot of paragraphs A to E, wherein when the robot drives in the second direction, a longitudinal axis of the robot is disposed at an angle with respect to a longitudinal axis of the confined area.
G. The robot of paragraphs A to F, wherein when the robot drives in the second direction, the robot drives a first distance and then rotates with respect to the second direction.
H. The robot of paragraphs A to G, wherein if the robot detects, via the at least one sensor, the first boundary or the second boundary, which prevents the robot from rotating less than or equal to 90 degrees relative to the second direction, the robot continues to drive in the second direction by a second distance.
I. The robot of paragraphs A to H, wherein if the robot detects, via the at least one sensor, the first boundary or the second boundary, which prevents the robot from rotating less than or equal to 90 degrees relative to the second direction, the robot continues to drive in the second direction by a third distance.
J. The robot of paragraphs A to I, wherein the first boundary or the second boundary prevents the robot from rotating less than or equal to 60 degrees relative to the first direction.
K. The robot of paragraphs A to I, wherein the first boundary or the second boundary prevents the robot from rotating less than or equal to 45 degrees relative to the first direction.
L. The robot of paragraphs A to K, wherein confined area defines multiple areas defined by the first boundary and the second boundary.
M. The robot of paragraphs A to L, wherein the sensor is a displacement sensor and comprises at least one of a hall effect sensor, motor current sensor, IMU sensor, a joystick sensor, a potentiometer, pressure switch, time of flight, capacitive, the like or combinations thereof.
N. The robot of paragraphs A to M, wherein the computing instructions are further configured, when executed by the processor, to cause the processor to:
detect by the at least one sensor, a third boundary as the robot travels in the second direction; actuate the motor maneuver the robot in a third direction, the third direction being at an angle to the second direction, and wherein travel in the third direction moves the robot away from the confined area into a second confined area having a third boundary and a fourth boundary.

This detailed description is to be construed as exemplary only and does not describe every possible aspect, as describing every possible aspect would be impractical, if not impossible. A person of ordinary skill in the art may implement numerous alternate aspects, using either current technology or technology developed after the filing date of this application.

Those of ordinary skill in the art will recognize that a wide variety of modifications, alterations, and combinations can be made with respect to the above-described aspects without departing from the scope of the invention, and that such modifications, alterations, and combinations are to be viewed as being within the ambit of the inventive concept.

The patent aspects at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality and improve the functioning of conventional computers.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular aspects of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A robot configured for cleaning, the robot comprising:
a body comprising a chassis and an outer perimeter, and the body further comprising a front portion, an opposing back portion, and a body length disposed between the front portion and the opposing back portion,
wherein the body further comprises a cleaning element positioned relative to the front portion,
wherein the front portion comprises a first side, an opposing second side, and a front portion width disposed between the first side and the second side;
a motor configured to move the robot within an environment;
at least one sensor;
a processor communicatively coupled to the at least one sensor;
a computer memory communicatively coupled to the processor; and
computing instructions stored on the computer memory and configured, when executed by the processor, to cause the processor to:
actuate the motor to drive the robot in a first direction, wherein the robot moves in a confined area within the environment, the confined area having a first boundary and a second boundary, and a confined area width extending between the first boundary and the second boundary, wherein the confined area width is sized greater than the front portion width of the robot;
actuate the motor to rotate the robot relative to the first direction;
detect, by the at least one sensor, that the first boundary or the second boundary prevents the robot from rotating less than or equal to 90 degrees relative to the first direction;
actuate the motor to maneuver at least a portion of the first side against the first boundary or at least a portion of the second side against the second boundary; and
actuate the motor to maneuver in a second direction, the second direction being an opposite direction relative to the first direction.

2. The robot according to claim 1, wherein the computing instruction stored on the computer memory and configured, when executed by the processor, to cause the processor to further: actuate the motor to remaneuver the robot in the first direction, wherein the robot drives along the first boundary or second boundary until the at least one sensor detects a third boundary which is disposed at an angle with respect to the first boundary or the second boundary.

3. The robot according to claim 2, wherein the third boundary is generally perpendicular to the first and/or second boundary.

4. The robot according to claim 1, wherein the computing instruction stored on the computer memory and configured, when executed by the processor, to cause the processor to further: actuate the motor to remaneuver the robot in the first direction, wherein the robot drives along the first boundary or second boundary to cover with the cleaning element at least one portion of the confined area not previously covered by the cleaning element when the robot was prevented from rotating by less than or equal to 90 degrees.

5. The robot according to claim 1, wherein the robot drives along the first boundary in the first direction, and wherein the robot drives along the second boundary in the second direction.

6. The robot according to claim 1, wherein when the robot drives in the second direction, a longitudinal axis of the robot is disposed at an angle with respect to a longitudinal axis of the confined area.

7. The robot according to claim 1, wherein when the robot drives in the second direction, the robot drives a first distance and then rotates with respect to the second direction.

8. The robot according to claim 1, wherein if the robot detects, via the at least one sensor, the first boundary or the second boundary, which prevents the robot from rotating less than or equal to 90 degrees relative to the second direction, the robot continues to drive in the second direction by a second distance.

9. The robot according to claim 1, wherein if the robot detects, via the at least one sensor, the first boundary or the second boundary, which prevents the robot from rotating less than or equal to 90 degrees relative to the second direction, the robot continues to drive in the second direction by a third distance.

10. The robot according to claim 1, wherein the first boundary or the second boundary prevents the robot from rotating less than or equal to 60 degrees relative to the first direction.

11. The robot according to claim 1, wherein the first boundary or the second boundary prevents the robot from rotating less than or equal to 45 degrees relative to the first direction.

12. The robot according to claim 1, wherein confined area defines multiple areas defined by the first boundary and the second boundary.

13. The robot according to claim 1, wherein the sensor is a displacement sensor and comprises at least one of a hall effect sensor, motor current sensor, IMU sensor, a joystick sensor, a potentiometer, pressure switch, time of flight, capacitive, or combinations thereof.

14. The robot according to claim 1, wherein the computing instructions are further configured, when executed by the processor, to cause the processor to:
detect by the at least one sensor, a third boundary as the robot travels in the second direction;
actuate the motor maneuver the robot in a third direction, the third direction being at an angle to the second direction, and wherein travel in the third direction moves the robot away from the confined area into a second confined area having a third boundary and a fourth boundary.
